(19) United States
(12) Patent Application Publication
(10) Pub. No.: US 2016/0260346 A1
(43) Pub. Date: Sep. 8, 2016

(54) SYSTEM AND COMPUTER METHOD PROVIDING CUSTOMIZABLE AND REAL-TIME INPUT, TRACKING, AND FEEDBACK OF A TRAINEE'S COMPETENCIES

(71) Applicant: FOUNDATION FOR EXXCELLENCE IN WOMEN'S HEALTHCARE, INC., Dallas, TX (US)

(72) Inventors: Taylor Lafrinere, Cary, NC (US); Mario Ashley Rodriguez, Raleigh, NC (US)

(21) Appl. No.: 14/635,238

(22) Filed: Mar. 2, 2015

(51) Int. Cl. G09B 19/00; G09B 5/06

(52) U.S. Cl. CPC G09B 19/00; G09B 5/06

(57) ABSTRACT

System and computer-implemented method of facilitating real-time competency-based feedback by a trainer to a trainee in a training environment for independent professional practice. An interactive session is initiated during or immediately following an interaction in the training environment for independent professional practice where the trainer observes during the interaction the trainee interacting with a third party. A user, which can be the trainee or trainer, enters a goal or a skill level rating for a competency or procedure in a first blade. A topic indicating the inputted information is published, and a subscriber manager is notified, which instructs a corresponding subscriber to instruct a second blade to refresh a score based on the inputted information. A server calculates a new score based on the inputted information, and only the second blade, but not the first blade, which is decoupled from the second blade, is refreshed to display the new score.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE PRESENT DISCLOSURE

Aspects of the present disclosure relate generally to systems and methods of improving interactions with a machine using an electronic human-machine interface and an electronic display, and more particularly, to providing a customizable and real-time input, tracking, and feedback of competencies of a trainee under observation by a trainer during an accredited residency or fellowship program or other apprenticeship program.

### BACKGROUND

Trainees, such as medical residents pursuing an accredited residency or fellowship program, rely on feedback from a more experienced trainer as they progress through the program. Regular feedback is one of many keys to a successful program that consistently produces high quality professionals whose core competencies have been assessed by faculty mentors and benchmarked against other residents and measurable performance and skill standards. Tracking residents' levels of core competencies throughout a medical program is presently disorganized, disjointed, and inefficient, which reduces overall quality. Moreover, tracking how a particular resident is faring against other residents in the same program is important for making peer comparisons and ensuring consistency in the progression of all the residents and common competencies that will ensure all residents complete the program with the same high level of qualifications against measurable standards.

There also tends to be a reluctance by a faculty or physician mentor to complete written evaluations or feedback, and there can be a time delay between when a faculty member observes a medical resident perform a skill or procedure and when meaningful feedback is supplied to the medical resident. This reluctance and delay reduces the overall quality of the program, and can result in inconsistencies and inefficiencies in administering the program. As a result, it is very time-consuming if not impossible to obtain a global understanding of how all residents and their mentors are tracking through the program.

### SUMMARY

According to an aspect of the present disclosure, a computer-implemented method of facilitating real-time competency-based feedback by a trainer to a trainee in a training environment for independent professional practice, using a computer, is disclosed. The method includes the steps of: during or immediately following an interaction in the training environment for independent professional practice where the trainer observes during the interaction the trainee interacting with a third party in which a medical service is being rendered to, or a medical procedure is being performed on, the third party by the trainer or by the trainee or by both, initiating an interactive session on a client computer and responsive thereto receiving input from a user interface device of the client computer indicative of at least one goal of a plurality of goals achieved by the trainee during the interactive session and causing to be displayed within a first frame on a display device of the client computer in the setting an indication of the at least one goal achieved, the plurality of goals being associated with a selected competency of a plurality of competencies and each of the plurality of goals being associated with one of a plurality of levels within the selected competency; publishing a topic indicating that the at least one goal has been achieved and notifying a subscriber manager controlled by a server computer that the input has been received relative to the first frame; a subscriber in the subscriber manager instructing a second frame to refresh a competency level score based on the received input indicating the at least one goal; and calculating a new competency level score for the selected competency based on the number of goals from among the plurality of goals inputted as being achieved by the trainee, and displaying simultaneously with the first frame, within the second frame on the display device, a representation based on at least the calculated competency level score without refreshing objects displayed in the first frame.

The method can further include the steps of: receiving, via the user interface device or another user interface device, authentication credentials associated with the trainee to login the trainee to the interactive session; responsive to authenticating the authentication credentials associated with the trainee, initiating the interactive session; after receiving the input from the user interface device and before the publishing, receiving a selection corresponding to a username of the trainer and displaying in the first frame, the second frame, or a further frame, an indication for the trainer to input an authentication credential associated with the trainer; receiving, via the user interface device or another user interface device, during the interactive session an authentication credential associated with the trainer to login the trainer to the interactive session; and responsive to authenticating the authentication credential associated with the trainer, receiving, via the user interface device, a confirmation to submit the input indicative of at least one goal and then carrying out the publishing.

The method can further include the step of during the interactive session, in response to receiving from the user input device a selection input selecting an object displayed in a selected frame displayed on the display device, where the selection input requires displaying additional information on the display device, displaying a new frame on the display device immediately adjacent to the selected frame.

The selected frame can be the first frame or the second frame or a further frame displayed on the display device. The new frame can be another of the first frame or the second frame or the further frame.

The method can further include the step of, each time a new frame is added to be displayed on the display device, displaying the new frame immediately adjacent to the last frame that was displayed on the display device, such that all frames displayed on the display device appear in a temporal order in which each such one of the frames was added to be displayed on the display device.

The method can further include the step of: during the interactive session, in response to receiving from the user input device an input to close any selected frame among a plurality of frames displayed on the display device, removing from display on the display device the selected frame and all other frames that were displayed after the selected frame.

The method can further include the step of: during the interactive session, in response to receiving from the user input device an input made in a selected frame among a plurality of frames displayed on the display device, removing from the display those of the plurality of frames that were added after the selected frame and displaying a new frame immediately adjacent to the selected frame.

The method can further include the steps of: displaying on the display device within a third frame a plurality of procedural steps performed within one of a plurality of procedures by the trainee; receiving input from the user interface device indicative of a skill level rating for a selected one of the plurality of procedural steps; publishing the inputted skill level rating to the subscriber manager; and calculating a skill level score for the selected procedure step based on the skill level rating, and displaying simultaneously within the third frame, within a fourth frame whose objects are controlled by a second subscriber on the display device, a representation based on at least the calculated skill level score without refreshing objects displayed in the third frame.

The method can further include the steps of: responsive to the interactive session being initiated by receiving authentication credentials associated with the trainee, displaying in the fourth frame an indication for the trainer to input an authentication credential associated with the trainer; receiving, via the user interface device or another user interface device, during the interactive session an authentication credential associated with the trainer to login the trainer to the interactive session together with the trainee; and responsive to authenticating the authentication credential associated with the trainer, receiving, via the user interface device, a confirmation to submit the input indicative of the skill level rating, wherein the displaying the representation based on at least the calculated skill level score is carried out responsive to receiving the confirmation to submit the input indicative of the skill level rating.

The first frame and the second frame can be decoupled from one another. The publisher can be decoupled from the subscriber.

According to a further aspect of the present disclosure, a computer-implemented method of facilitating real-time competency-based feedback from a trainer to a trainee in a training environment for independent professional practice, using a computer, is disclosed. The method includes the steps of: initiating, responsive to authenticating authentication credentials associated with the trainee or responsive to authenticating authentication credentials associated with the trainer, an interactive session on a computer; during the interactive session, receiving, via a user interface device associated with the computer, inputs indicative of a plurality of goals achieved by the trainee, each of the goals being associated with one of a plurality of competency levels related to the independent professional practice; responsive to receiving each of the inputs indicative of the plurality of goals achieved by the trainee and during the interactive session, computing a competency level score for the associated one of the competency levels based on those of the goals achieved by the trainee and associated with the associated one of the competency levels, wherein the computing the competency level score is carried out only when the authentication credentials associated with the trainer have been authenticated; responsive to the computing, displaying on a display device a representation based on at least the competency level score during the interactive session; during the interactive session, receiving, via the user interface device, inputs indicative of a plurality of skill level ratings each associated with one of a plurality of procedural steps related to the independent professional practice; responsive to receiving each of the inputs indicative of the plurality of skill level ratings and during the interactive session, computing a skill level score based on those of the skill level ratings for the associated one of the plurality of procedural steps, wherein the computing the skill level score is carried out only when the authentication credentials associated with the trainer have been authenticated; responsive to the computing, displaying on the display device a representation based on at least the skill level rating during the interactive session; and responsive to the interactive session being initiated responsive to authenticating the authentication credentials associated with the trainee: receiving during the interactive session, via the user interface device or another user interface device, authentication credentials associated with the trainer; and authenticating the authentication credentials associated with the trainer to log the trainer in to the interactive session with the trainee.

The representation based on at least the calculated competency level score can be a color-coded bar or a progress meter. The representation based on at least the calculated competency level score can also be based on at least scoring bias, a frequency of scoring by the trainer, or trend information indicative of an assessment of the trainee's scores or overall progress in the training environment.

Additional aspects of the present disclosure will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a functional block diagram of a system 100 according to an aspect of the present disclosure.

FIG. 2 is a functional block diagram of an example publish-subscribe model showing five blades.

FIG. 3 illustrates an example journey showing blades as they are displayed on the display device in a time-ordered sequence.

FIG. 4 illustrates an example functional block diagram showing entry of multiple authentication credentials to change data displayed in a blade.

FIG. 5A is an example journey as displayed on a display device, starting with a main navigation menu in which a user selects the milestones-type feedback to provide or review.

FIG. 5B shows the user selecting resident R5 to evaluate for feedback, which immediately causes a summary blade appear on the display device next to the home blade.

FIG. 5C shows the user selecting a first competency under a milestone, which immediately causes an insights blade to appear on the display device next to the summary blade.

FIG. 5D shows the result of the user selecting “full history” on the insights blade, which immediately causes a history blade to appear on the display device next to the insights blade.

FIG. 5E shows the result of the user selecting faculty member F2 to provide feedback for the selected milestone or competency, which immediately causes a check-in blade to appear on the display device next to the history blade.

FIG. 5F shows the result of the faculty member F2 entering authentication credentials to submit feedback on the selected milestone, which immediately causes any other blades impacted by the submitted feedback to update their data and display, if visible on the display device, the changed data.

FIG. 6A is another example journey as displayed on a display device, starting with a main navigation menu in which a user selects the surgical skills-type feedback to provide or review.

FIG. 6B shows the result of the user selecting surgical skills, which immediately causes a home blade to appear on the display device next to the main navigation menu.

FIG. 6C shows the result of the user selecting one of the procedures on the home blade for review or evaluation, which immediately causes an insights blade to be displayed on the display device next to the home blade.

FIG. 6D shows the result of the user selecting to review the full history of the selected procedure, which immediately causes a history blade to be displayed on the display device next to the insights blade.

FIG. 6E shows the result of the user selecting “start feedback” on the insights blade, which immediately causes a feedback blade to be displayed on the display device next to the insights blade.

FIG. 6F shows the result of the user selecting a faculty member F5 to provide a review of the selected procedure, which immediately causes a new feedback blade to be displayed next to the feedback blade.

FIG. 6G shows the user, which can be the resident R1 or the faculty member F5, entering feedback on the new feedback blade for the selected procedure.

FIG. 6H shows the user going back to the procedures blade and selecting a different procedure for review or evaluation, which causes all other blades to be removed from the display device and a new insights blade for the newly selected procedure to be displayed on the display device next to the procedures blade.

FIG. 6I shows the result of the user selecting to review the full history for the newly selected procedure, which immediately causes a history blade showing a list of faculty members who have submitted feedback for the newly selected procedure to be displayed on the display device next to the insights blade.

FIG. 6J shows the result of the user selecting a faculty member to update previously submitted feedback, which immediately causes a feedback blade to be displayed next to the history blade showing the previously submitted feedback.

FIG. 6K shows the result of the selected faculty member updating previously submitted feedback by entering authentication credentials in the feedback blade to submit the updated feedback.

FIG. 7 is an example journey as displayed on a display device, starting with a main navigation menu in which a user selects to view overall stats on all the residents participating in the training program.

### DETAILED DESCRIPTION

While this disclosure is susceptible of embodiment in many different forms, there is shown in the drawings and will herein be described in detail example implementations of the inventions and concepts herein with the understanding that the present disclosure is to be considered as an exemplification of the principles of the inventions and concepts and is not intended to limit the broad aspect of the disclosed implementations to the examples illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

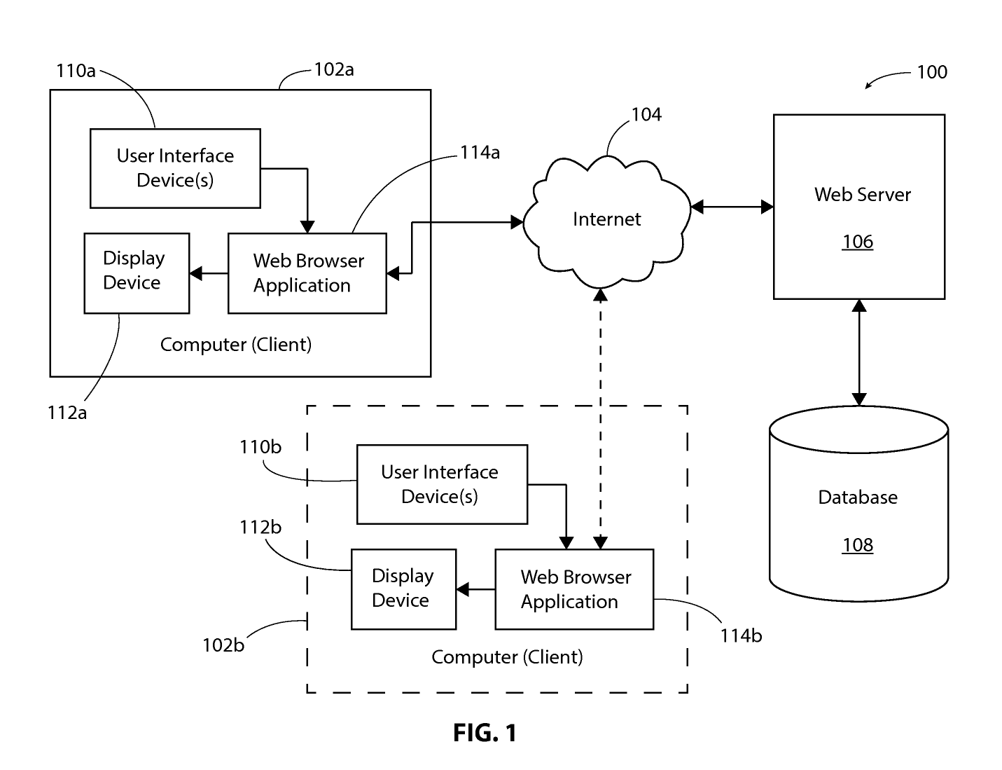

FIG. 1 is a functional block diagram of a system 100 according to an aspect of the present disclosure. The system includes one or more computers (clients) 102a, 102b, which can be coupled together via a network, such as the Internet 104. A computer as used herein includes any one or more electronic devices having a central processing unit (CPU) or controller as understood by those skilled in the art of computing. Examples of computers include tablet computers, laptop computers, desktop computers, servers, smartphones, a wearable electronic device such as a watch, an eyeglass, an article of clothing, or a wristband, and personal digital assistants (PDAs). The term computer as used herein can include a system of electronic devices coupled together to form what is conventionally referred to as a computer. For example, one or more input devices, such as a keyboard or a mouse, and one or more electronic display devices, such as a video display, can be coupled to a housing that houses the CPU or controller. Or, all components of the computer can be integrated into a single housing, such as in the case of a tablet computer or a smartphone. The one or more computers 102a, 102b conventionally include one or more memory devices that store digital information therein, including non-transitory machine-readable instructions and data. Each of the one or more computers 102a, 102b includes a user interface device 110a, which corresponds to a human-machine interface that accepts inputs made by a human (e.g., via touch, click, gesture, or voice) and converts those inputs into corresponding electronic signals. Examples of user interface devices include a touchscreen, a keyboard, a mouse, a camera, and a microphone. Each of the one or more computers 102a, 102b also includes a display device 112a, 112b configured to display information that can be visually or aurally perceived. Examples of display devices include a video display, a stereoscopic display, or any electronic display capable of visually portraying information including text, static graphics, and moving animations that is perceivable by the human eye. A web browser application 114a, 114b resides on each of the one or more computers 102a, 102b. The web browser application 114a, 114b conventionally conveys information between the computer 102a, 102b and the Internet 104 via a conventional wired or wireless electronic communications interface associated with the computer 102a, 102b. A reference number without a letter can refer to either or both items to which it refers. Thus, the reference number 102 can refer to the computer 102a or the computer 102b or both the computer 102a and 102b.

A web server 106 is also coupled to the Internet 104. The web server 106 is a type of computer, and has a well understood meaning in the art. An electronic database 108 is incorporated in or is coupled to the web server 108. The database 108 is a form of a memory device or a data store, and stores electronic data for retrieval and archival relative to the web server 106. Both the web server 106 and the one or more web browser applications 114a, 114b communicate information according to the hypertext transfer protocol (HTTP). In the case of a private local area network (LAN), instead of the Internet, any other communications protocol can be used instead of the HTTP, and the web browser applications 114a, 114b can instead be proprietary applications that communicate using a proprietary or conventional communications protocol to pass information between the computer 102a, 102b and the server 106.

Some aspects of the present disclosure use a publish-subscribe model, as that term is understood by software programmers, in a way that is different from conventional usage. In these aspects, the publish-subscribe model can be used, but does not necessarily have to be used, for refreshing changed objects displayed on the display device 112a, 112b without refreshing other objects that do not need to be updated. This allows the data collections, contained within frames or “blades,” to be decoupled from one another, and also reduces a phenomenon coined as UI churn, which refers to the frequency or overhead associated with refreshing objects on a video display. The way that present disclosure uses the publish-subscribe model according to some but not all aspects disclosed herein reduces the number of states that must be maintained and updated internally, which results in a faster and more efficient delivery of real-time information. Additional benefits include the ability to reuse blades and modularity. A blade once instantiated can be reused at a later time as needed even if it removed from display on the display device 112. The data structure associated with the blade can be reused and instantly re-invoked at will by a manager. The modularity of the architecture allows the system 100 to be expanded or shifted into other applications as there is no limit to the number of blades or the size(s) of each blade. These and other technical improvements are manifested increasingly as the number of computers 102 is increased in the system 100. While the present disclosure discusses the publish-subscribe model as one non-limiting way of managing information in the system 100, other conventional ways are also contemplated as not all inventions disclosed herein need to rely on the publish-subscribe model disclosed herein.

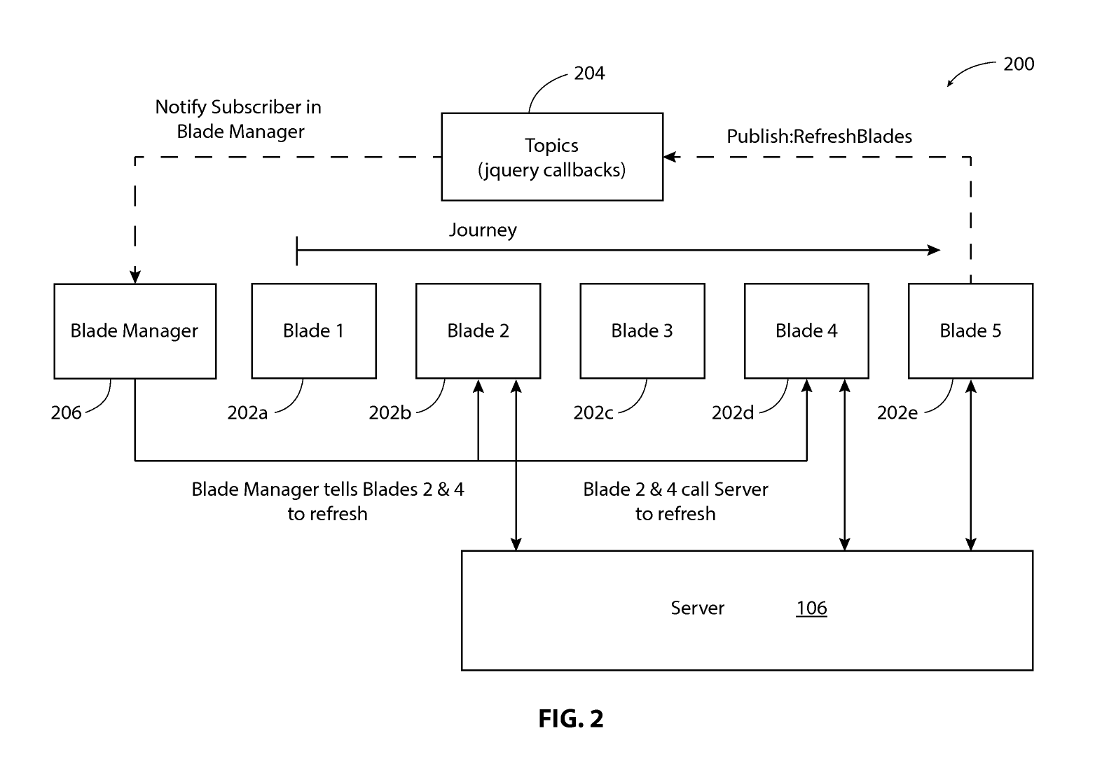

The terms “blade” and “frame” are used synonymously herein, although the term “frame” can be loosely used to refer to the actual displayed object on the display device 112, whereas a blade can refer to the underlying data structure, although this distinction is not necessarily adhered to throughout this disclosure. A blade or a frame includes a collection or “container” of objects, as understood by computer programmers, and can be decoupled from other blades or frames. The term “decoupled” includes “loosely coupled” as skilled programmers understand those terms. The terms “completely” or “totally” decoupled refer to blades and frames that do not pass any parameters or information directly between any other blades or frames such that a particular blade does not have any awareness of other blades. All information can be conveyed from one blade to another using the publish-subscribe model. As data structures, each blade can be viewed as an independent container of objects, divorced from other blades and only coupled to one another via a publish-subscribe model, like the one shown in FIG. 2.

FIG. 2 is a functional block diagram of an example publish-subscribe model 200 showing five blades (or frames) 202a-202e in this example instantiated on the computer 102. Each of the blades 202a-202e has been displayed on the display device 112 in a temporal sequence, which is referred to herein as a journey. Thus, the blade 202a was the first blade to be displayed on the display device 112, followed by the blade 202b, and so on. One of the blades, in this example the blade 202e, publishes a topic called RefreshBlades to a Topics Manager 204. The Topics Manager 204 interprets the topic RefreshBlades and notifies a corresponding subscriber in a Blade Manager 206. The Blade Manager 206 includes subscriptions to topics and associated with each of the blades 202a-202e, and can instruct any one or more of the blades to take further action. In this example, the corresponding subscription to the RefreshBlades topic published by the blade 202e requires that the blades 202b and 202d refresh one or more objects being displayed on the display device 112. The Blade Manager 206 instructs the blades 202b and 202d to refresh, and the blades 202b and 202d call a server, such as the web server 106, to refresh. Any data manipulation or calculations required to update objects associated with the blades 202b, 202d are carried out by the web server 106. For example, if an object associated with the blades 202b, 202d needs to be updated on the display device 112, the web server 106 will return the value(s) or other parameters required for the blades 202b, 202d to refresh on the display device 112. No other blades are refreshed, which means that blades 202a, 202c, and 202e are not refreshed while blades 202b and 202d are being refreshed. Particularly as the system 100 grows by adding more computer clients 102 and more blades are added, the amount of UI churn is dramatically reduced. Concomitantly, the number of states required to be tracked by the various computing devices in the system 100 is dramatically reduced, allowing for a seamless (visually) and real-time flow and update of information on many computers 100 in the system 100 simultaneously, even if that information is not necessarily immediately displayed or viewable on the display devices 112 (e.g., as in the case of a tablet computer or smartphone, where the size of the display is relatively small compared to a stand-alone computer monitor).

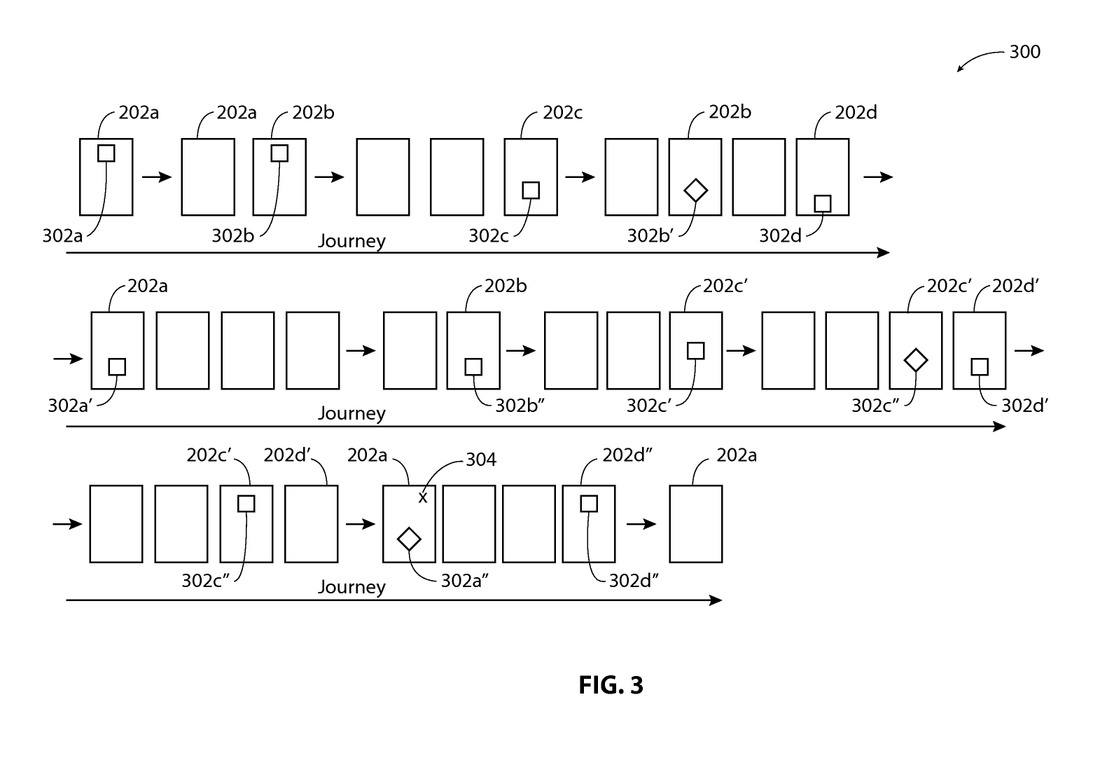

FIG. 3 illustrates an example journey 300 showing one or more blades as they are displayed on the display device 112 in a time-ordered sequence. Starting in the upper left, a first blade 202a is displayed on the display device 112 and includes at least one selectable element 302a. The selectable element 302a can be selected via the user interface device 110, such as by clicking on a mouse, as that term is understood in the computer art, or touching an area on a touchscreen corresponding to a graphical element displayed on the display device 112, for example. In response to the selectable element 302a being selected, a second blade 202b is added and displayed on the display device 112. When the display device 112 is, for example, a smartphone, there may not be a sufficient width available in the viewable area of the display device 112 to display the entirety of the first and second blades 202a, 202b. In such a case, as much or all of the second blade 202b is displayed on the display device 112, and if possible, some or none of the first blade 202a is also displayed. Optional horizontal and/or vertical scroll bars can be displayed along edges of the blades 202 to allow the user to scroll in any direction to view obscured or hidden blades, which would otherwise be viewable on a larger display. Alternately or additionally, when the user interface device 112 includes a touchscreen, the user can swipe with a finger or conductive device to scroll in any direction to view obscured or hidden blades. Other multi-point gestures such as pinch-to-zoom gestures can be used to zoom in or out allowing more or fewer blades to be displayed in the viewable area of the display device 112. On the other hand, when the display device 112 is, for example, a widescreen video display having, for example, a 2K or 4K resolution, it is possible to display many blades, such as 5, 6, 7, or more, simultaneously on the viewable area of the screen. A display device 112 on a tablet computer, for example, might only have sufficient width to display 2, 3, or 4 blades simultaneously on the viewable area of the screen.

One or more blades can be static, such as for example, the first blade 202a. Though not necessary, the first blade 202a can be always present, even if it is not viewable on the display device 112. The first blade 202a is thus where each “journey” starts, and presents a list of selectable elements 302 for the user to select to continue and expand the journey by adding new blades.

The user interface display schema displays only those blades that are relevant to the user's selections of selectable elements in other blades. The display schema is dynamically updated based on user inputs and changes to data that are necessitated by a user input, but, in a non-limiting aspect of the present disclosure, only those blades that experience a user input or a change in the data displayed on those blades are refreshed using the publish-subscribe model discussed above. For display devices having a relatively small viewable area, such that only a few blades can be viewed simultaneously, this display schema reduces UI churn, is highly modular and scalable, and simplifies the user experience so that only information relevant to the user's most immediate input is displayed on the display device. Blades that are no longer relevant due to a user input are removed from the display, as will be discussed in connection with the example journey shown in FIG. 3.

Returning to the second part of the example journey 300 shown in FIG. 3, a second selectable element 302b is shown in the second blade 202b. Note that any user input can be accepted as a selectable element, including text or other input inputted by the user of the client computer 102. A text entry object where text is entered via the user interface device 110 also constitutes a selectable element as used herein. Again, the content displayed in the second blade 202b is relevant to the information indicated by the selectable element 302a. In other words, had the user made a different selection, different content would be displayed in the second blade 202b. When the second selectable element 302b is selected, a third blade 202c is added in a third part of the journey to the display device 112 and displayed thereon. More selectable elements in the third blade 202c are displayed, including a third selectable element 302c. In this example, the user selects the third selectable element 302c, which brings the user to the fourth part of the journey where a fourth blade 202d is added and displayed on the display device 112 along with a fourth selectable element 302d. Here, the user's selection of the fourth selectable element 302d causes a value to be changed, and this changed value might be reflected in an earlier-instantiated blade, such as the second blade 202b. Here, a data element that is graphically portrayed or represented as a graphical element 302b′ in the second blade 202b is updated dynamically as the fourth selectable element 302d is selected. If the second and fourth blades 202b, 202d are viewable simultaneously on the display device 112, when the user selects the fourth selectable element 302d, the graphical element 302b′ will be refreshed and changed dynamically and in real-time such that the user will immediately see the changed graphical element 302b′. For example, the graphical element 302b′ can represent a numerical value whose value changes in response to the selection of the fourth selectable element 302d in the fourth blade 202d. As mentioned above, the web server 106 can carry out calculations to change the value represented by the graphical element 302b′ and then publish the changed value to the subscribing blade. Of course, although only one graphical element 302b′ is shown in this example journey being refreshed, other graphical elements in other blades can also be refreshed if their underlying data has been changed in response to the selection of the fourth selectable element 302d.

Still referring to the example journey 300 shown in FIG. 3, following the selection of the fourth selectable element 302d, the user goes back to the first blade 202a to make a different selection of a fifth selectable element 302a′. As mentioned above, the first blade 202a can be a static blade displaying a static menu or list of selectable elements. While selectable elements can be added or removed from this static menu or list, the first blade 202a will always display the menu or list. For example, when the training environment or training program is a medical residency program, the first blade 202a can include a list of medical residents or a list of faculty mentors, each of which corresponds to a selectable element. In this example journey 300, the user selects the fifth selectable element 302a′, which as can be seen in the next part of the journey 300, causes the third and fourth blades 202c, 202d to be removed from display. The second blade 202b remains, and the user selects a sixth selectable element 302b″ in the second blade 202b, which causes a new blade 202c′ to appear as a third blade on the display device 112. In this new third blade 202c′, the user selects selectable element 302c′, which causes a new blade 202d′ to appear as a fourth blade on the display device 112. The selectable element 302d′ is selected, causing data displayed in the third blade 202c′ to be changed, which is rendered graphically by a graphical element 302c″. Only the third blade 202c′ is refreshed in response to the selection of the selectable element 302d′ in the fourth blade 202d′.

With all four blades still present, 202a, 202b, 202c′, 202d′, the user decides to go back to the third blade 202c′ and select a selectable element 302c″ displayed in the third blade 202c′. Selecting the selectable element 302c″ causes a new blade 202d″ to appear as a fourth blade, replacing the previously displayed blade 202d′. The user selects a selectable element 302d″ in the fourth blade 202d″, which causes data in the first blade 202a to be changed, which is rendered graphically in representation form by a graphical element 302a″ in the first blade 202a. All of the blades can also include a close box 304, which is shown in this part of the journey but not elsewhere for ease of illustration, which the user can select at any time to close one or more blades. In this example, when the user selects the close box 304 in the first blade 202a, all blades after the first blade 202a are removed from the display device 112, leaving only the first blade 202a on the display device 112. It will be appreciated that this example journey is but just one example of innumerably conceivable example journeys that one or more users may choose to implement. The example interactions shown in FIG. 3 exemplify an aspect of how each blade 202 is its own container and is decoupled from all other blades, and how an interaction in one blade can cause data to be changed in another blade, where only the blade or blades where data has been changed in response to the interaction is or are refreshed on the display device 112. If a user chooses to close a particular blade, then all other blades that were displayed following the blade being closed are removed from display. As mentioned above, removed blades can be reused despite being no longer viewable on the display device 112. Only those blades relevant to the interaction at hand are displayed on the display device 112. For example, it may be possible to instantiate 30 or 40 different blades during any given session, but only those few that are relevant to the interaction at hand are actually displayed on the display device 112. Changed values or data are updated dynamically and in real time in a visual representation form so that the new values or new data can be viewed immediately in the same or a different blade on the display device 112.

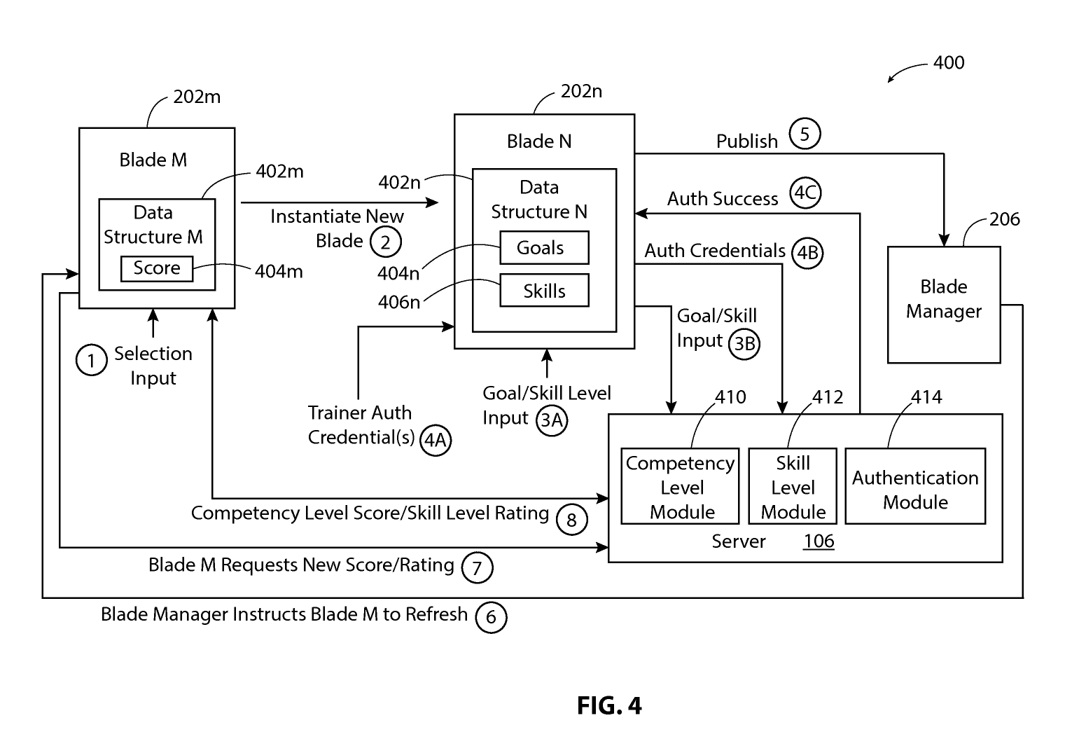

FIG. 4 illustrates an example functional block diagram with a numbered time sequence of actions 400 in which multiple authentication credentials are required to change data displayed in a blade. In this example, a trainee, such as a medical resident, has used his or her authentication credentials to cause a blade 202m to be displayed on the display device 112. The blade 202m includes a data structure 402m, which includes objects, including a score element 404m. The score element 404m can correspond to a graphical element, such as those discussed in FIG. 3 above, that is displayed in the blade 202m on the display device 112. The sequence of events in this example proceeds as follows.

1. A selection input is received via the user interface device 110 of an element displayed in the blade 202m. For example, this selection input can correspond to a selection of a particular competency or skill of the trainee to be rated or assessed.

2. A new blade 202n is instantiated, which does not necessarily need to be immediately following the blade 202m. In other words, there can be other intervening blades that are instantiated and displayed prior to the new blade 202n being displayed on the display device 112. The new blade 202n includes a data structure 402n, which can include one or more goal elements 404n or one or more skill elements 406n or both. These elements can correspond to graphical elements displayed in visual representation form within the blade 202n on the display device 112. Once instantiated, the blade 202n is displayed and viewable on the display device 112.

3A. Either the trainee or his or her trainer (such as a faculty member) inputs a goal or skill level via one or more selectable elements in the blade 202n. During this example session, both the trainee and trainer are present simultaneously and interacting with the computer 102. The trainee can “masquerade” as the trainer and enter feedback that would normally be entered by the trainer, but as explained above, feedback (such as relating to a competency, goal, or skill exemplified or achieved by the trainee under assessment) can only be submitted when authentication credentials of the trainer have been entered and accepted.

3B. A goal or a skill or other input relating to an assessment of a competency of the trainee is inputted into the data structure 402n, which communications that input to the server 106. A competency level module 410 or a skill level module 412 in the server 106 receives the input and calculates a competency level score or a skill level rating, respectively. A module as used herein can refer to a software module as that term is understood in the computer programming art. As discussed above, a competency level score or a skill level rating cannot be updated until authentication credentials associated with the trainer have been authenticated.

4A. The trainer inputs into the data structure 402n his or her authentication credential(s). The credentials can include, for example, a username and corresponding password or a biometric attribute (fingerprint, iris, voice) associated with the trainer.

4B. The data structure 402n communicates the inputted authentication credentials to an authentication module 414 of the server 106. The authentication module 414 conventionally authenticates received authentication credentials and indicates at its output whether the received credentials have been authenticated.

4C. If so, the authentication module 414 communicates to the data structure 402n an indication that the received credentials have been successfully authenticated. In this example, a trainee has used his or her authentication credentials to login initially to this session. However, if the trainer has logged into the session, steps 4A-4C are eliminated. The trainer simply inputs the goal or skill level (step 3A), and the data structure 402n publishes to the Blade Manager 206 an indication that new data has been entered in blade 202n.

5. The data structure 402n, having the requisite permission to publish the goal or skill level input received from the trainer, sends a publish request to the Blade Manager 206 to refresh whatever appropriate blade (which is unknown to the blade 202n) needs to update data as a result of the inputted goal or skill level input.

6. The corresponding subscriber associated with the blade 202m in the Blade Manager 206 instructs the blade 202m to refresh the score object 404m with new data.

7. The data structure 402m requests the new score or rating from the competency level module 410 or the skill level module 412, as appropriate, in the server 106. The server 106 performs any calculations necessary for generating the new score or rating, using the inputted goal or skill level input received in 3A above.

8. The server 106 communicates the new competency level score or skill level rating to the data structure 402m, which updates the score 404m object and displays the new score or rating in the blade 202m on the display device 112.

The computer-implemented methods and implementations described herein facilitate real-time competency-based feedback by a trainer to a trainee in a training environment or training program for independent professional practice, using one or more computers. Real-time means that there is no perceptible delay as perceived by the human senses between adjacent events controlled by the computer(s). The feedback described herein, using one or more computers, is competency-based, which means that the feedback assesses the trainee's competence at various procedures, mastery of various skills, or the like. Examples of a training environment include a hospital, an operating room, a doctor's office where a patient is examined or other medical examination room, a medical facility, or a university or college where medicine is taught. Examples of independent professional practice include medicine, dentistry, law, or any other practice relating to a specialized learned profession, typically where the professional must hold a valid professional license or certification (such as from a state authority) to carry out professional services. Examples of a trainee include a medical resident, as that term is understood in the medical profession, or any other type of apprentice being prepared for independent professional practice. The term independent in independent professional practice refers to the personal nature of the license or certification that will be bestowed upon the trainee once experienced professionals have determined that the trainee possesses a minimum set of competencies to apply for a license or certification for professional practice.

In the examples that follow, a very specific implementation will be discussed, but the present disclosure is hardly limited to these specific implementations. In these examples, the trainee is a medical resident, seeking to become a licensed obstetrics and gynecology (OB/GYN) physician, and is being assessed by one or more licensed physicians. Again, while the examples are specific to an OB/GYN program, the aspects of the present disclosure can be applied to any other professional program as discussed above.

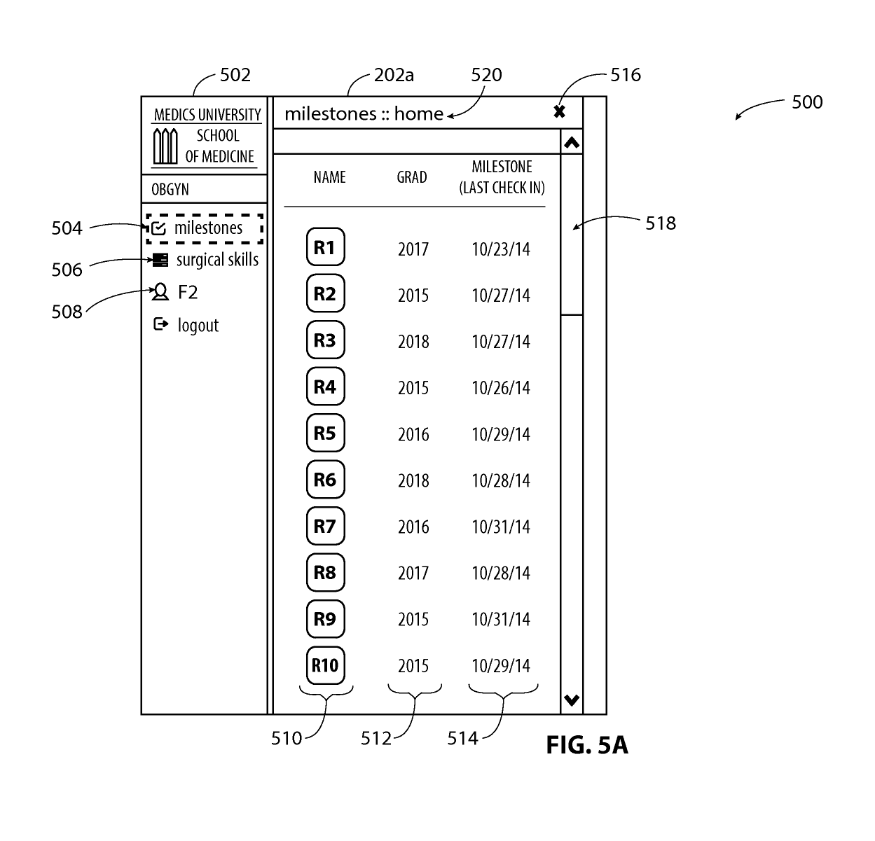

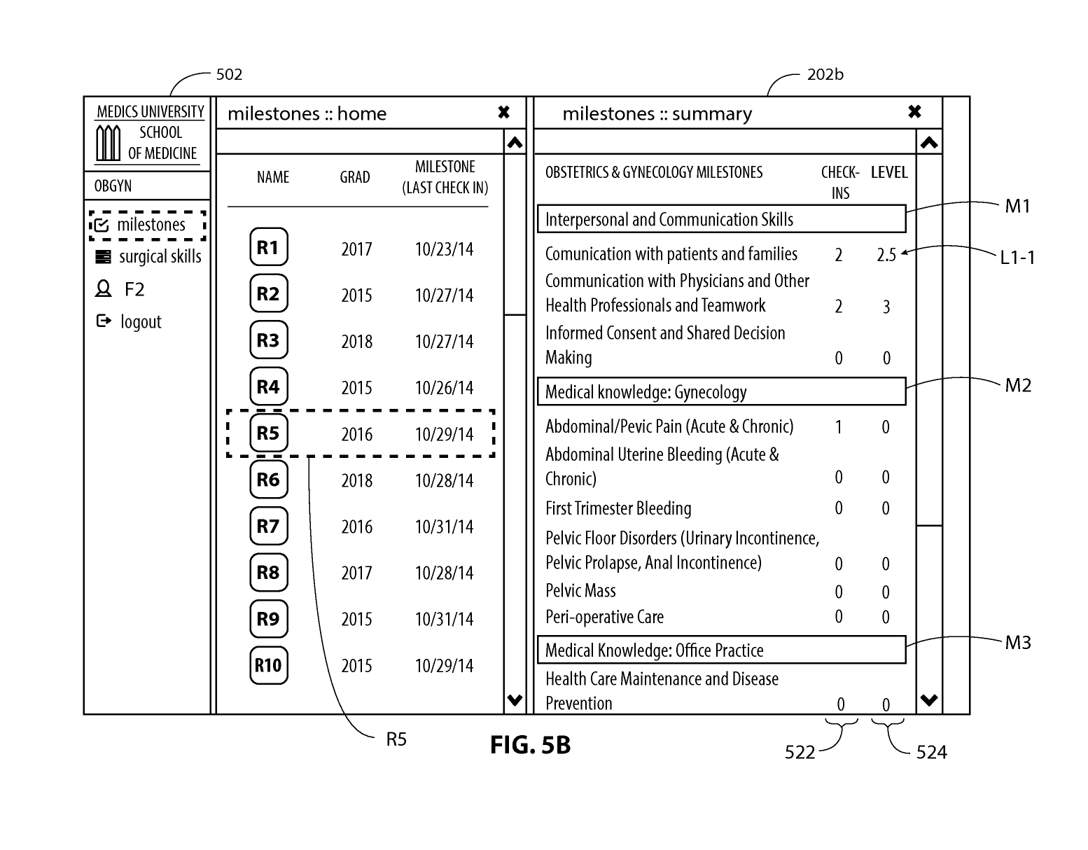

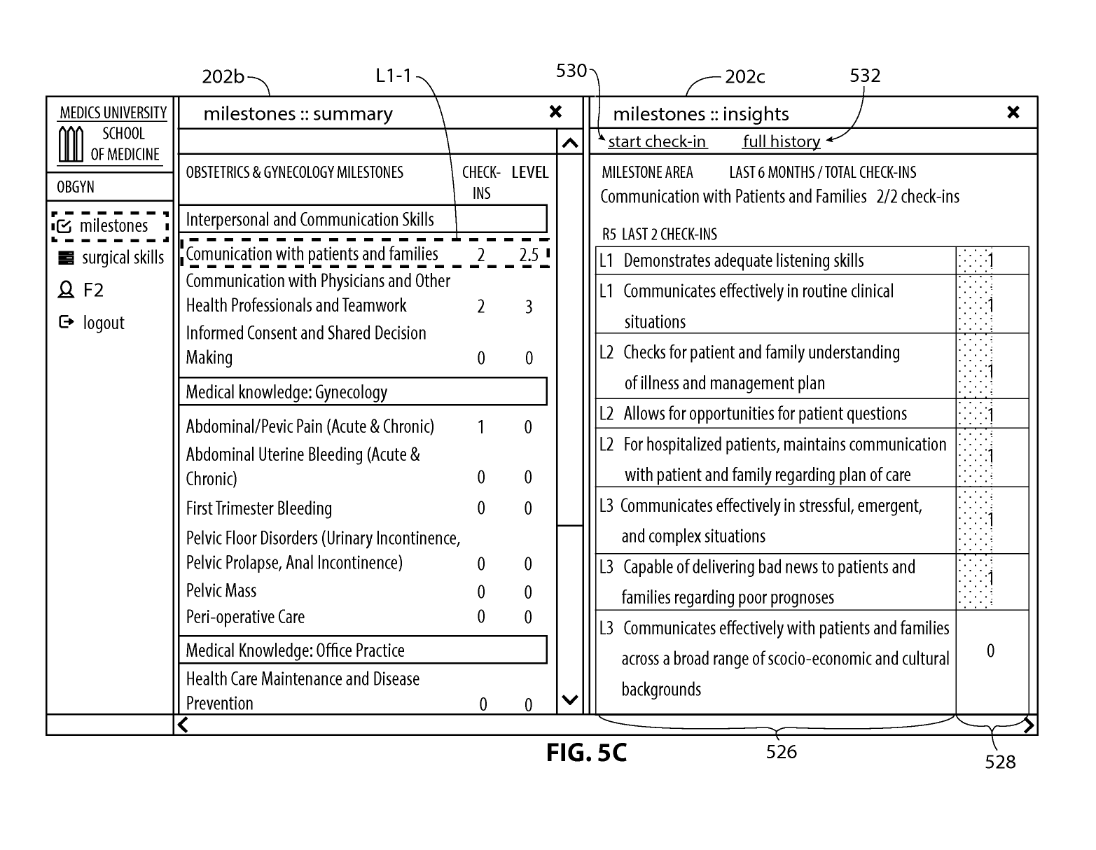

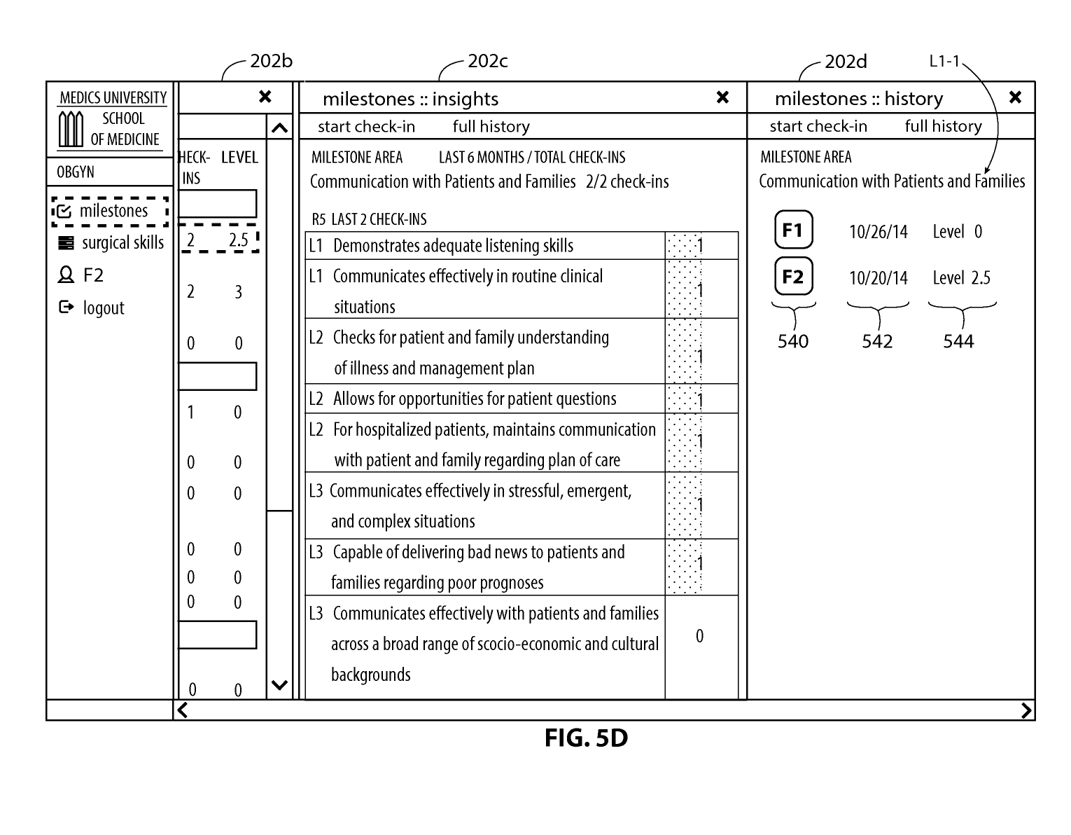

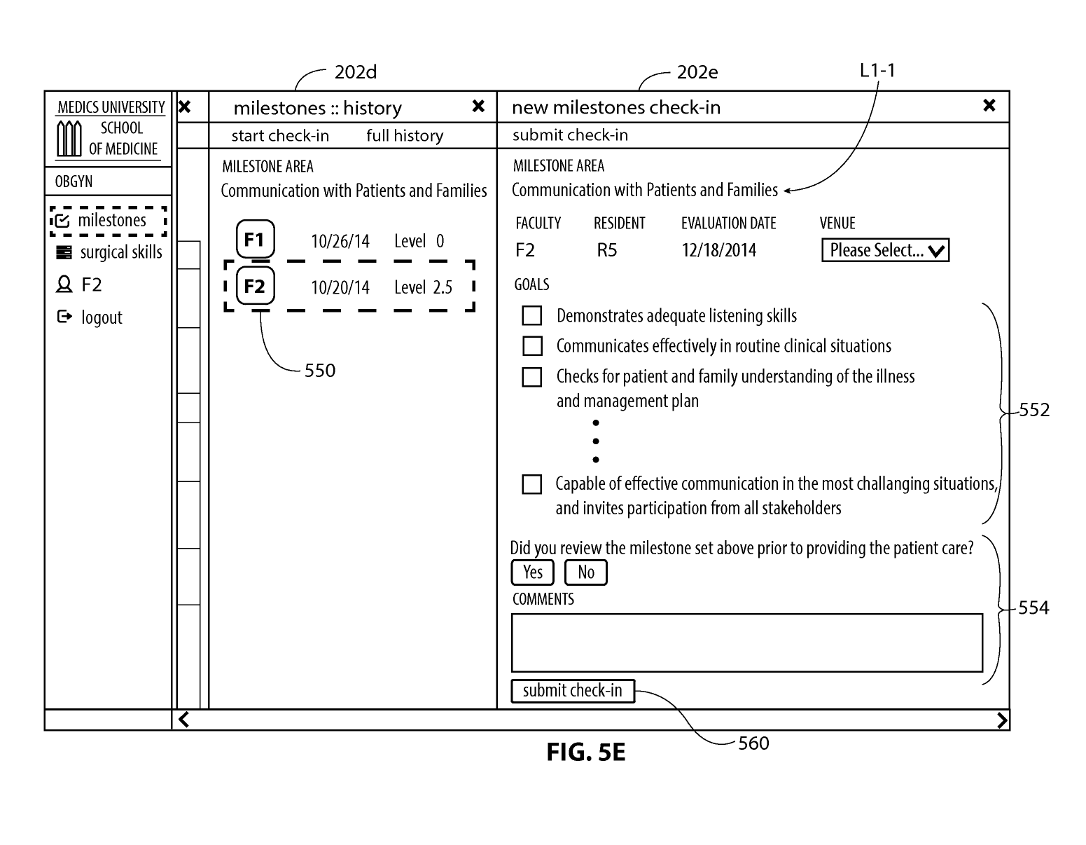

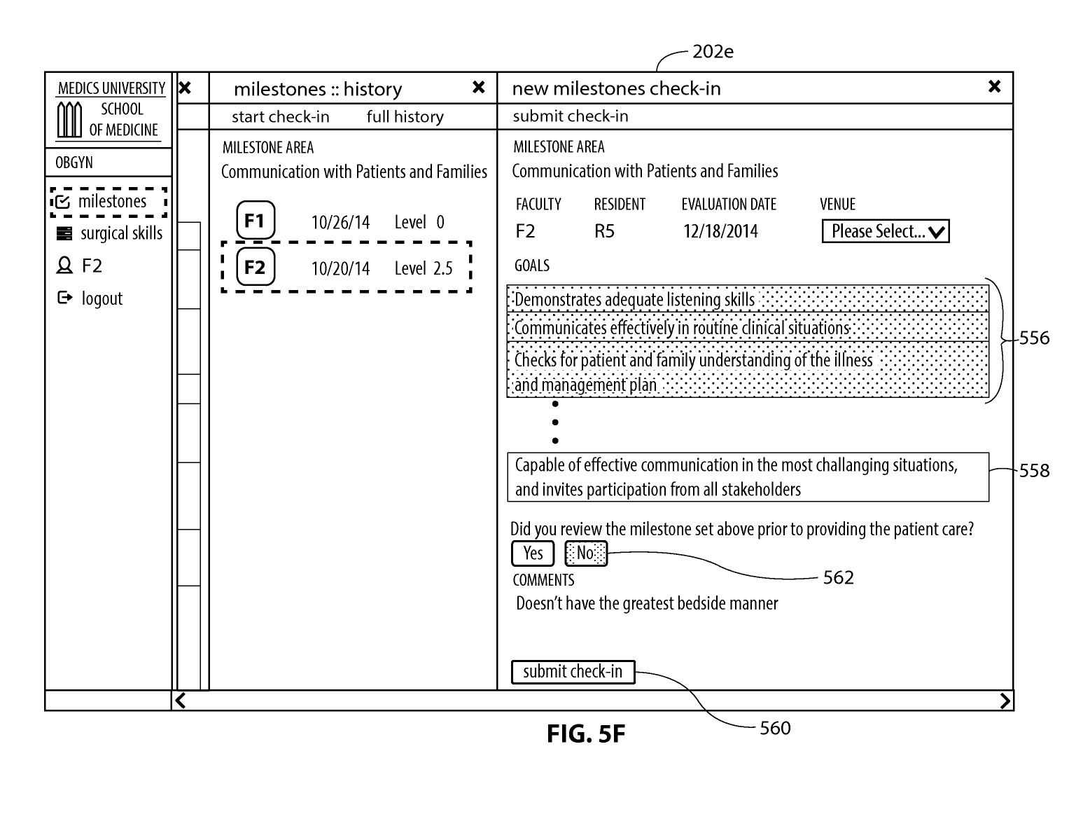

In a first example journey 500 shown in FIGS. 5A-5F, a main navigation menu 502 is shown on the leftmost side of the display device 112. This main menu 502 is always displayed on the display device 112 no matter how many blades are shown to the right of the menu 502. This menu 502 shows the name of the hospital or university associated with the feedback being carried out, and the particular medical specialty, which in this example is OB/GYN. A selectable element 504 bearing the label “milestones” is presented on the display device 112 along with another selectable element 506 bearing the label “surgical skills.” In these examples, there are two types of feedback that can be provided. One evaluates overall competencies mastered by the trainee, here called milestones, and the other evaluates surgical skills in the operating room mastered by the trainee. In this example, a trainer or faculty member, designated by F2 in the area 508, has logged into the interactive session to evaluate one or more trainees or residents. Thus, the faculty member F2 has already supplied his or her authentication credentials, and is therefore authorized in this interactive session to submit feedback on the trainee(s) under evaluation. An interactive session as used herein can begin with the logging in of a trainee or trainer, and can be completed when the logged in user logs out. In this example, the trainer and trainee are together in person during an interactive session, allowing feedback to be shared in a collaborative manner during the interaction as the feedback is entered into the computer 102 by either the trainee or the trainer and then submitted by the trainer.

In this example, the trainer has selected the “milestones” selectable element 504 as indicated by the rectangle with dashed lines. When the trainer clicks or taps on the selectable element 504 via the user interface device 110, a “home” blade 202a is displayed immediately adjacent to the main menu 502. The reference number 202 is used here to indicate that the blades in FIGS. 5A-5F are examples of the blades shown and described in connection with FIGS. 2-4. A navigation header 520 at the top of the home blade 202a displays the user's place in the journey. Here, the navigation header 520 indicates that the user is starting a journey. In the home blade 202a, the user is presented with a list of residents 510, which can include their initials, a photograph of a face of the corresponding resident, and/or any other indicia to readily distinguish one resident from another. The next column in the home blade 202a displays the expected year of graduations 512 of each resident shown in the list 510. The third column in the home blade 202a displays the last check-in date 514 where feedback was submitted for each resident. A close button 516 is displayed in the upper right corner of the home blade 202a to allow the user to close the home blade 202a, which will remove it from display on the display device 112. An optional vertical scroll bar 518 allows the user to scroll among all of the residents in the list 510, which can extend beyond the viewable area of the display device 112. When the computer 102 is a tablet computer or smartphone, for example, only one or two blades might be viewable simultaneously on the display device 112. Horizontal scroll bars can also be introduced as more blades are added to the viewable area of the display device 112 to allow horizontal scrolling to expose blades that were hidden or obscured due to limitations in the screen size of the display device 112.

In FIG. 5B, the user has selected resident R5 to evaluate, as indicated by the dashed horizontal box. Once the resident R5 is selected, a second “summary” blade 202b is displayed immediately next to the home blade 202a. The summary blade 202b includes multiple “milestones” M1, M2, M3, and so forth, and beneath each milestone, there is displayed one or more competencies L1-1, etc. associated with each milestone. For example, the first milestone M1 is interpersonal and communication skills. Under this milestone, there are three different competencies displayed: Communication with patients and families (L1-1), Communication with physicians and other health professionals and teamwork (L1-2), and Informed consent and shared decision making (L1-3). The second milestone M2 is medical knowledge, and specifically in this example, gynecology. Under the medical knowledge milestone M2, there are six different competencies displayed: Abdominal/pelvic pain (acute & chronic), Abdominal uterine bleeding/acute & chronic), First trimester bleeding, Pelvic floor disorders (urinary incontinence, pelvic prolapse, anal incontinence), Pelvic mass, and Peri-operative care. The third milestone corresponds to another type of medical knowledge, which in this example is office practice. The competencies for this third milestone are displayed, and so on. The second blade 202b also displays the number of check-ins 522 for each competency. This number represents the number of times this competency has been evaluated by a faculty member. Next to the number of check-ins 522 is a column of competency level scores, which are determined as discussed below.

In FIG. 5C, the user has selected the first competency under the first milestone M1, communication with patients and families, for evaluation. As soon as this selection is made, a third “insights” blade 202c is displayed on the display device 112. Depending on the available viewable area, older blades may now be obscured from view. In this example, the first home blade 202a is no longer visible on the display device 112 in favor of the new insights blade 202c that was just instantiated. In the insights blade 202c, two selectable elements 530, 532 are displayed. The first one 530, labeled “start check-in,” if selected, begins a check-in where feedback about a milestone or a skill can be submitted. The second selectable element 532, labeled “full history,” if selected, allows the user to view the full history of the feedback submitted for the selected competency. A summary of the goals 526 needed for the selected competency to be achieved by the trainee under evaluation (here, R5) is displayed along with a list of the goals that have been at least partially achieved in the estimation of a faculty member (528). For those goals that have only been partially achieved, a colored bar can indicate visually what percentage of that goal has been achieved. This colored bar is an example of a representation that is based at least on a calculated score. For example, when the percentage achieved does not exceed a threshold, such as 50%, the colored bar can appear as a red color to indicate at a glance to the user that this area needs improvement. Otherwise, if the percentage achieved meets or exceeds the threshold, the colored bar can appear as a green color. These instant “insights” available on the display device 112 to the user inform the user (both trainee and trainer alike) of the areas where the trainee might want to concentrate further efforts and energy. This and other progress bars or indicia described herein to represent a trainee's individual and relative progress through a training program can be based on at least the calculated score (e.g., competency or skill level score), but can also be based on additional information, including trend information, time between observations for the competency or skill or procedure under assessment, and evaluation criteria, for example. Trend information can include a historical assessment of the trainee's scores for a particular competency or skill or procedure, or an assessment of the trainee's overall progress as a whole in the training program. For example, a red color code can be used to reflect improvement in an area where the trainee would have otherwise received a green color code if the codes were calculated based on scores alone, but when historical trends that show a vulnerable improvement pattern are taken into account, the trainee is assessed a red color code in the area under evaluation. Evaluation criteria by an evaluator (or reviewer) can include factors such as faculty or scoring bias. For example, a green color code can be used where the trainee would have otherwise received a red color code if the codes were calculated based on scores alone, but where one, some, or all of the scores were received from a faculty member or trainer who is known to be a harsher evaluator. The weight assigned to such a faculty member and more lenient evaluators can be lower compared to faculty members who assign reasonable scores fairly and evenly.

In FIG. 5D, the user has selected the second selectable element 532 indicating a desire to view the full history of evaluations for the competency selected in the summary blade 202b. Once the full history element 532 has selected, a “history” blade 202d is displayed immediately adjacent to the insights blade 202c. Here, a list 540 of all the faculty members who have provided an evaluation for the selected competency is shown. In this example, two faculty members, F1 and F2, have submitted feedback for the competency selected in the second blade 202b. A list of dates 542 showing the last time each faculty member provided feedback is displayed, and the competency level score associated with each faculty member. In this example, faculty member F2 last submitted feedback on Oct. 20, 2014, and based on the feedback submitted, the competency level score of the resident R5 is currently assessed to be 2.5.

In FIG. 5E, the user has selected the start check-in selectable element 530 for the faculty member F2 as indicated by the box 550. Upon selecting this selectable element 530, a check-in blade 202e is displayed immediately adjacent to the history blade 202d. In the check-in blade 202e, the user can enter feedback (e.g., in the form of identifying goals achieved by the medical resident) associated with the competency L1-1 selected in the summary blade 202b. The competency L1-1 under evaluation is displayed in the check-in blade 202e, along with the faculty member (F2) evaluating the resident, the resident (here, R5), the evaluation date, and a venue where the resident was under observation (e.g., any of the training environment examples discussed above). Under the selected competency L1-1, a list of goals 552 is displayed that are selectable elements. The user simply needs to click on or touch the selectable element (such as a checkbox) to select it. The user can quickly select which goals were achieved with just a single human-machine interaction. Each goal description is displayed with the corresponding selectable element in the check-in blade 202e. The check-in blade 202e also asks whether the milestone or competency L1-1 was reviewed with the medical resident prior to providing the patient care, and also provides a comment text entry box for the reviewer to enter comments. A selectable element 560 in the form of a submit button appears at the bottom of the check-in blade 202e. Here, because the credentials of the faculty member, F2, have already been authenticated, no further authentication credentials need to be received to submit feedback entered into the check-in blade 202e. As discussed above, selecting the submit button 560 causes the blade 202e to publish to the Blade Manager 206 that data has changed, whereupon the server 106 determines which blade needs to refresh and then instructs that blade to refresh its data.

In FIG. 5F, the user has selected the first three goals by selecting them (556), and the selected goals are highlighted on the display device 112. Some goals, such as the goal 558 was not selected and remains an outstanding goal that the resident will need to achieve to have fully mastered this particular competency or milestone. Once the submit button 560 is selected, the server 106 calculates or updates the competency level score associated with the selected competency L1-1, and instructs the summary blade 202b to refresh and display the updated value for the competency level score for competency L1-1. This occurs in real-time so that if the summary blade 202b is viewable on the display device 112 at the same time that the check-in blade is also viewable, then the user immediately sees the changed value in the summary blade 202b.

The example journey 500 shown and described in connection with FIGS. 5A-5F illustrate how a faculty member can provide feedback in the form of indicating goals achieved by the medical resident under evaluation for milestones or competencies. The main menu 502 also allows the faculty member to evaluate any resident's surgical skills by selecting the surgical skills selectable element 506.

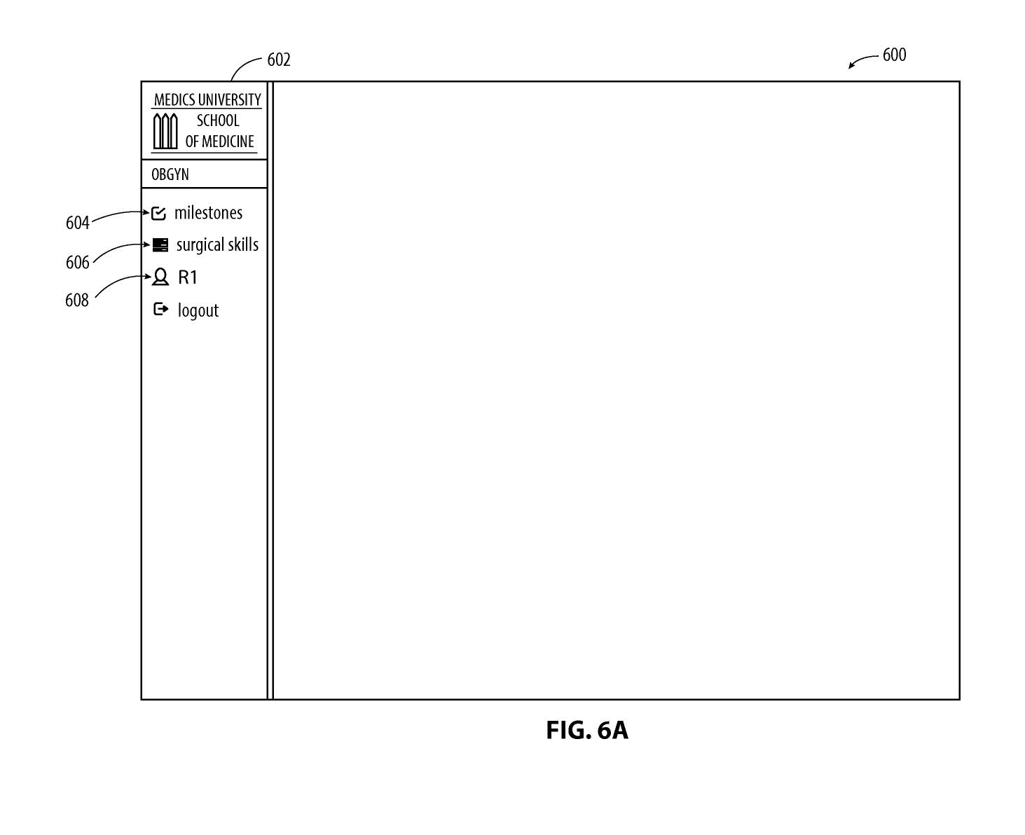

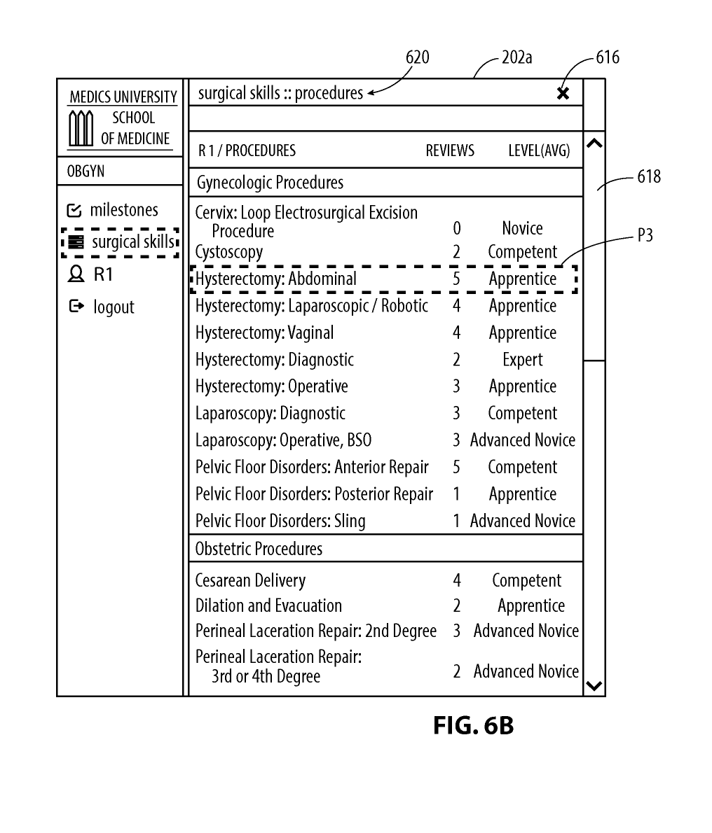

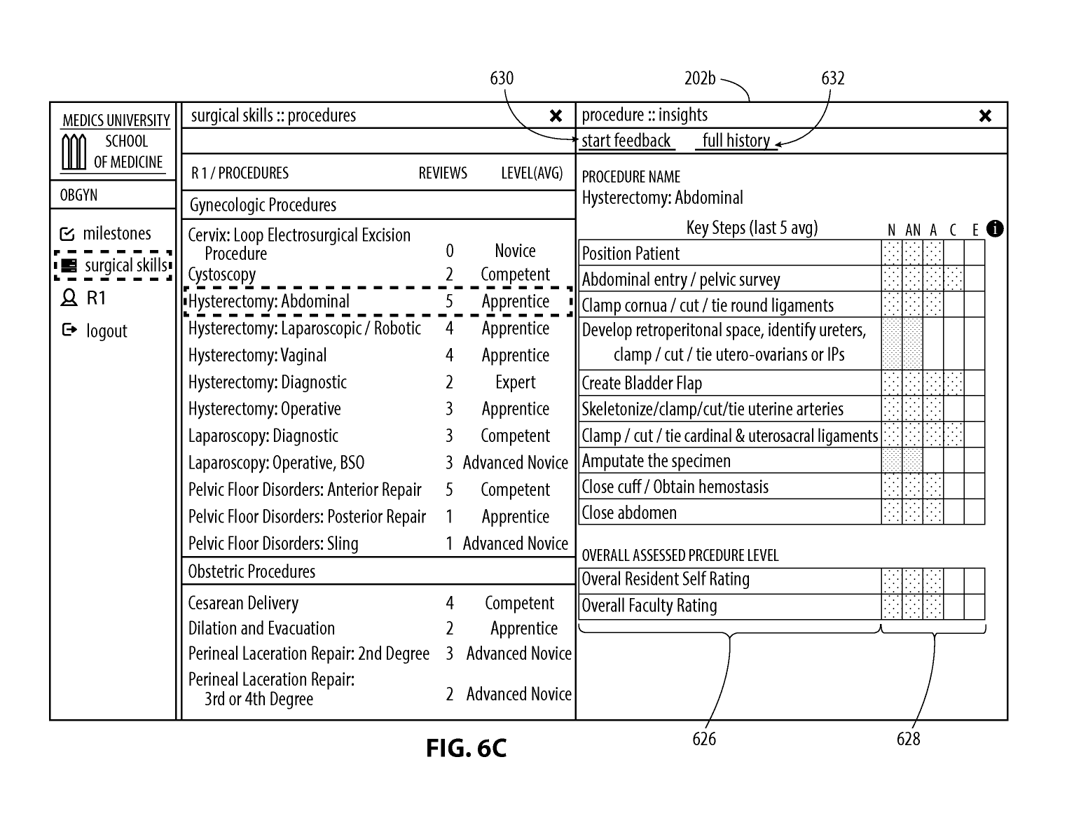

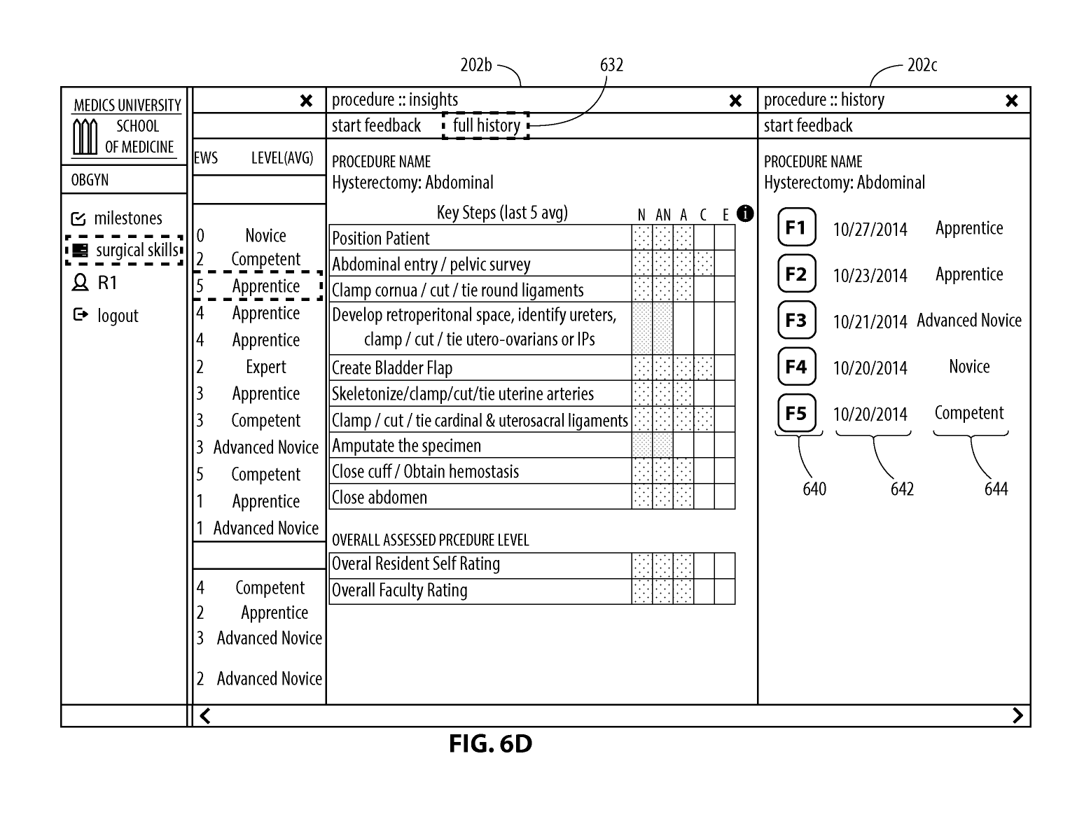

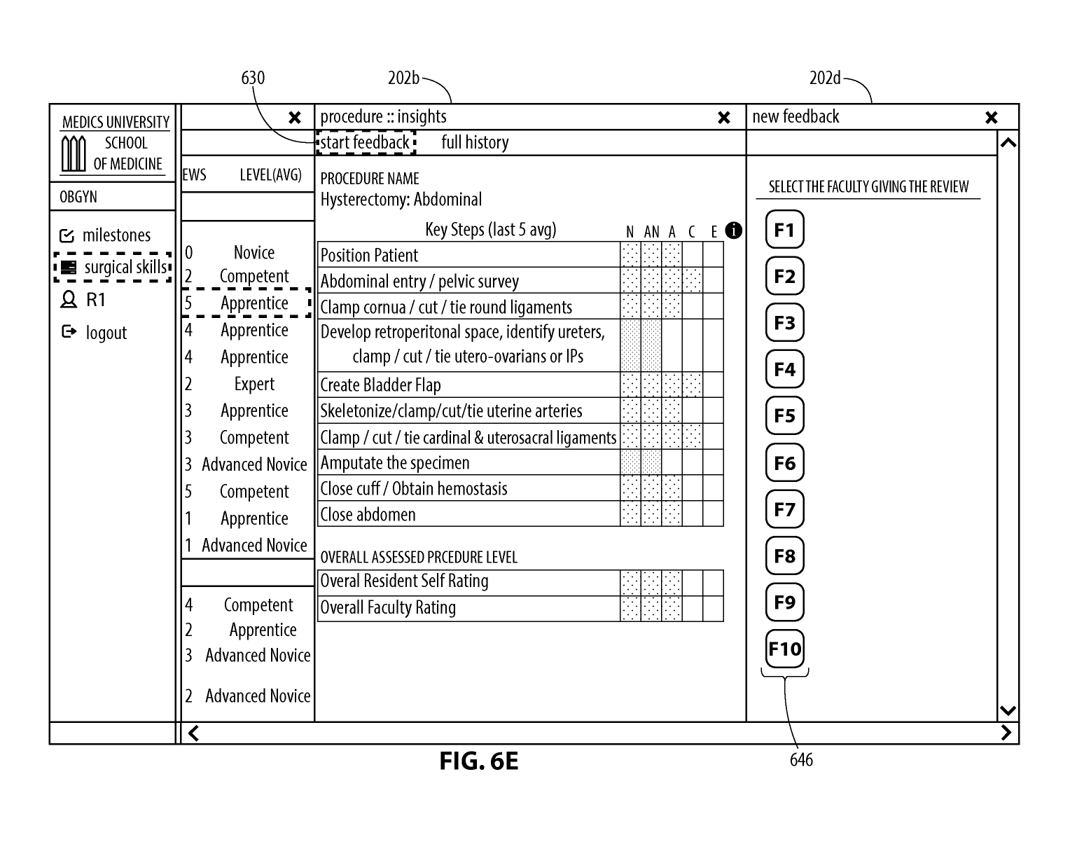

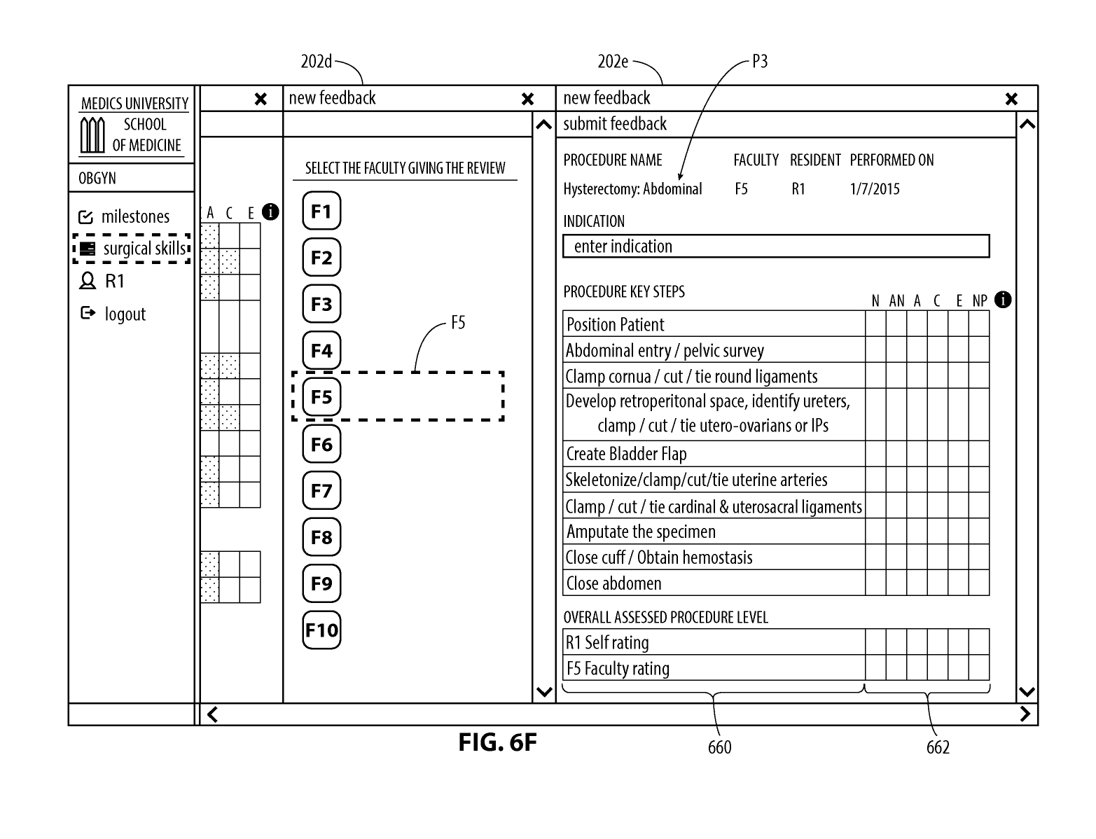

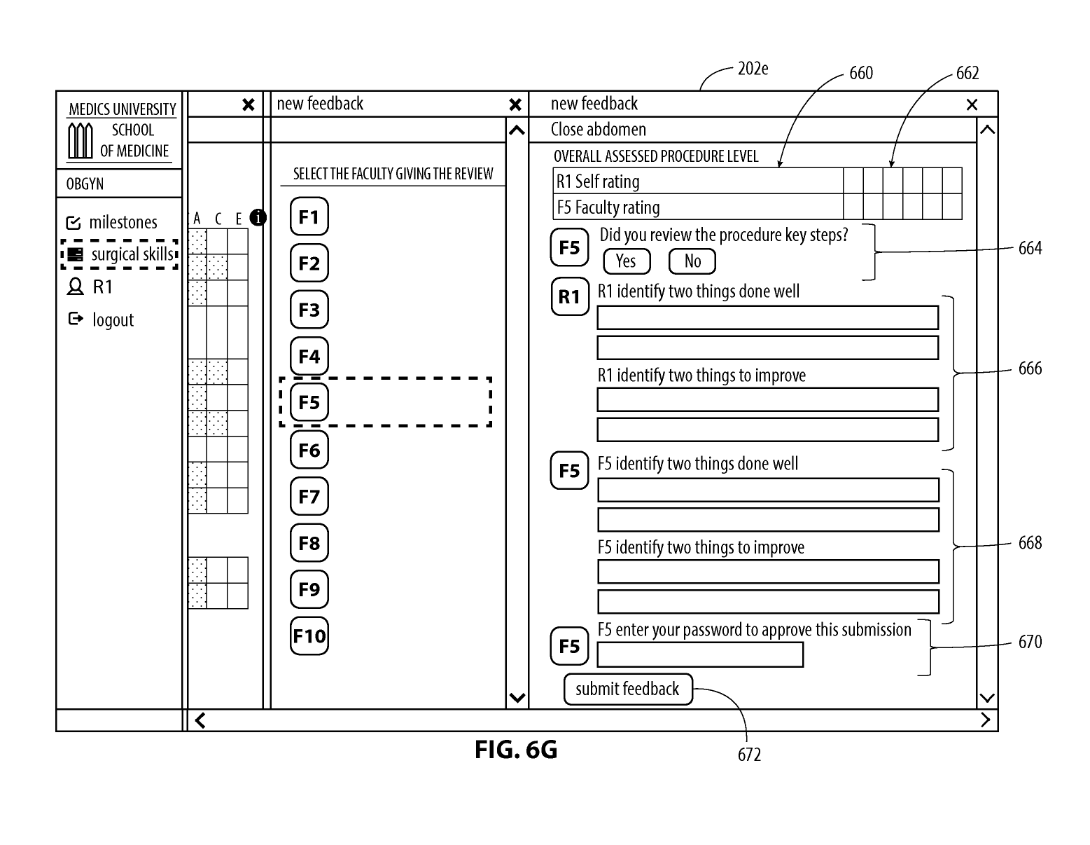

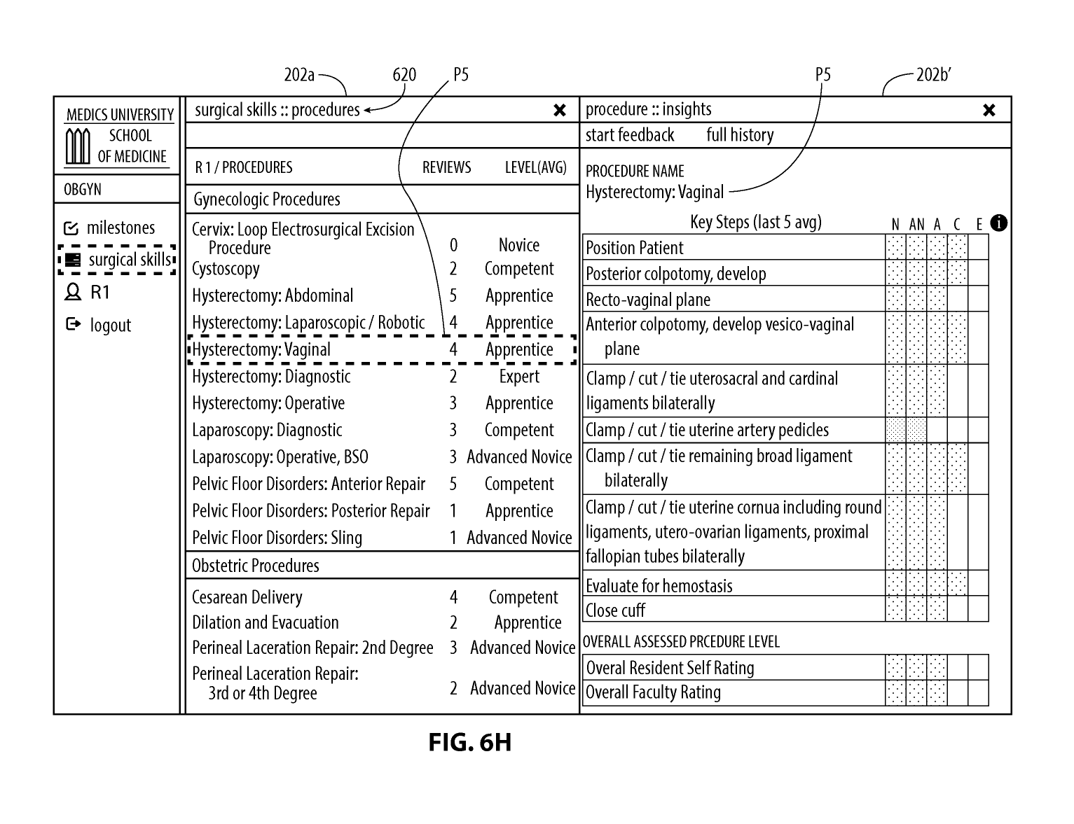

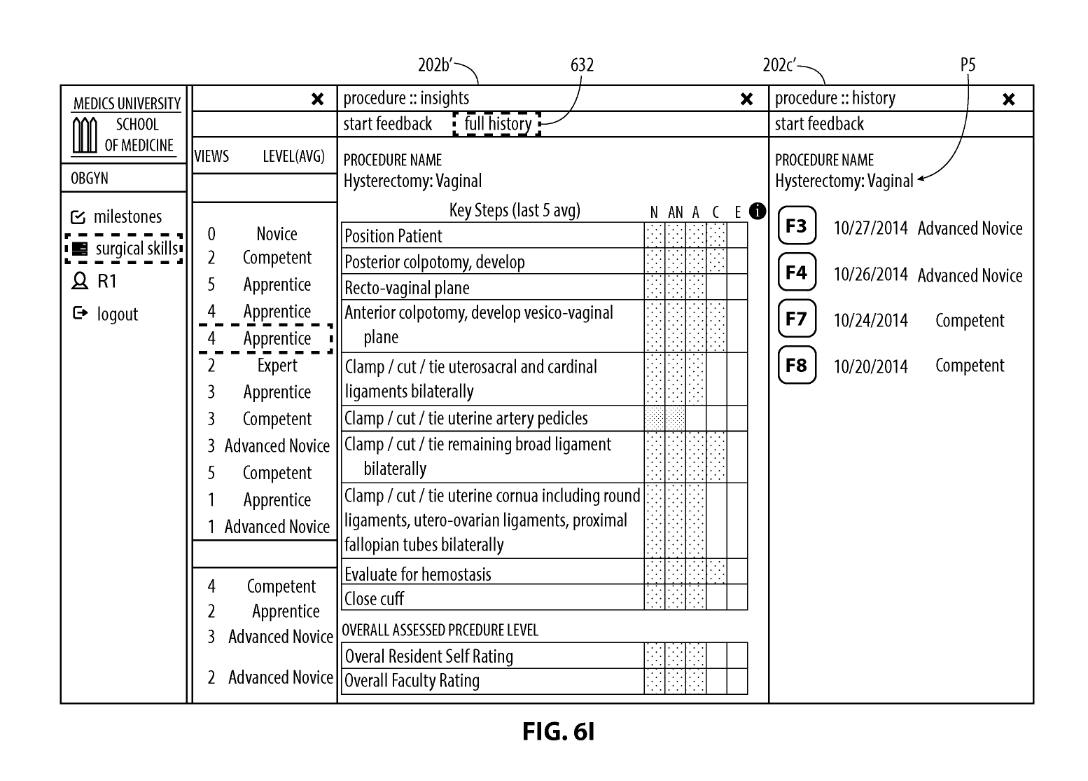

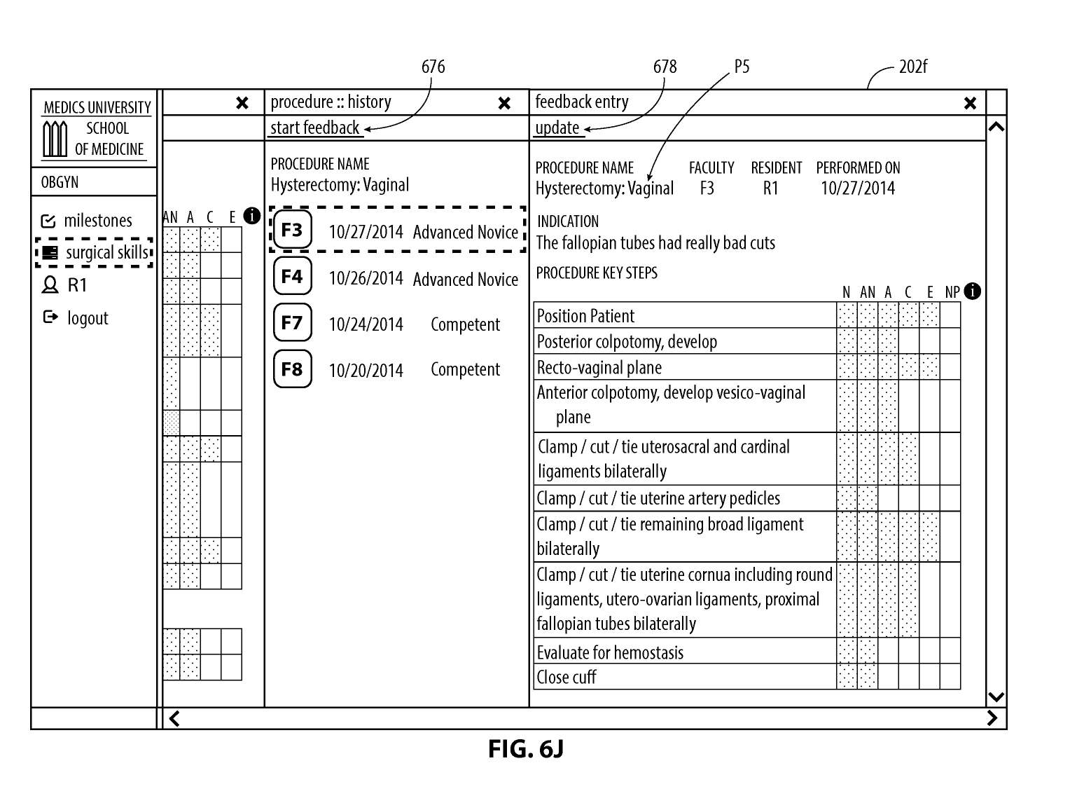

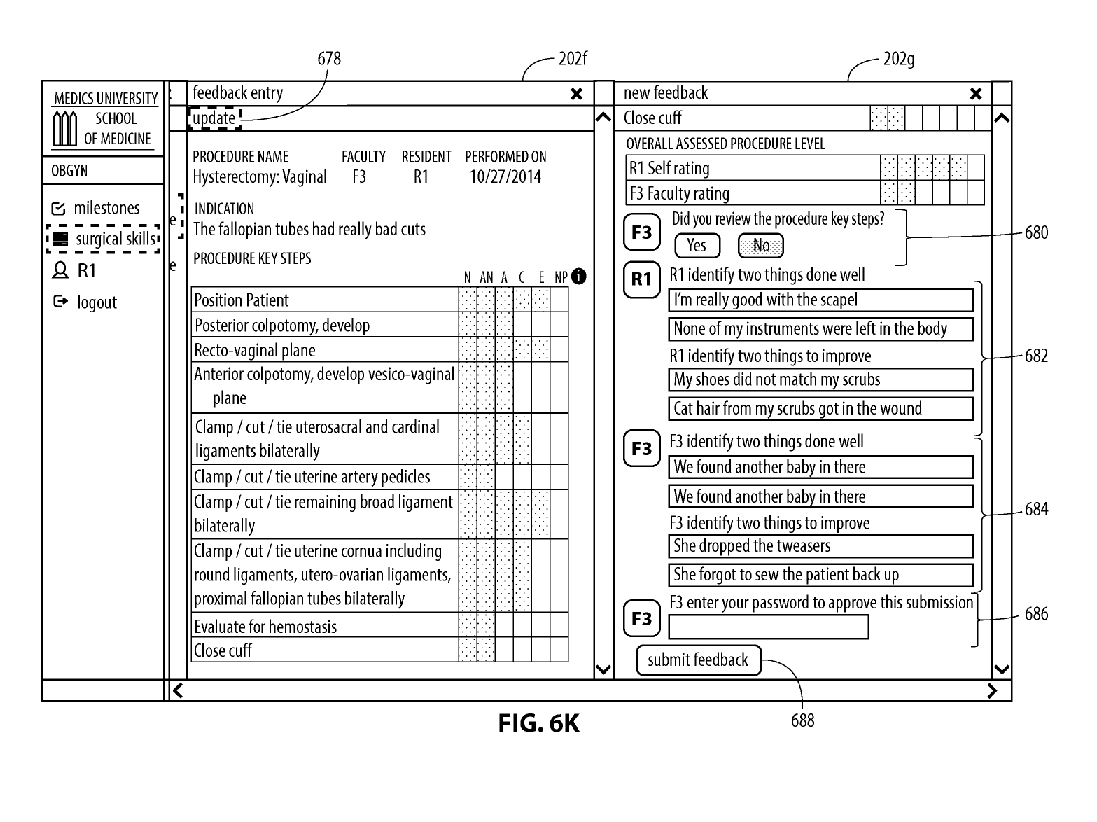

Another example journey 600 is shown in FIGS. 6A-6K. In this example journey, a resident instead of a faculty member logs into the session, and instead of selecting milestones, selects surgical skills for evaluation. Because the resident has logged into the session, a faculty password is required to submit feedback, as explained in more detail below.

In FIG. 6A, a main navigation menu 602 is shown, similar to the menu 502 shown in FIG. 5A. Two selectable elements 604, 606 labeled “milestones” and “surgical skills,” respectively, are shown. In this example, a trainee or medical resident, designated by R1 in the area 608 on the menu 602, has used his or her credentials to log into the interactive session and gain access to the menu 602. As shown in FIG. 6B, the user (here the resident R1) has selected the selectable element 606 labeled “surgical skills,” which instantly calls up a home blade 202a, which includes a navigation header 620 at the top of the home blade 202a that displays the user's place in the journey 600. Here, the home blade 202a displays numerous (surgical) procedures for which the resident R1's competency can be evaluated. In this example, a number of gynecologic and obstetric procedures are listed, each of which is associated with a selectable element. A vertical scroll bar 618 allows the user to scroll up or down to view the entire list of procedures. A selectable element in the form of a close button 616 is also displayed on the home blade 202a. Each procedure also shows the number of reviews or evaluations this resident R1 has received, along with the assessed skill level score assigned by those trainers who have submitted evaluations for the resident for the procedure in question. The skill level score can be expressed as a quantity, or, as in this example, expressed as one of different levels. Here, there are five levels of expertise that a trainee can achieve, starting from lowest to highest, novice (N), advanced novice (AN), apprentice (A), competent (C), and expert (E).

As soon as the user selects the selectable element P3 shown in FIG. 6B, an insights blade 202b is displayed immediately thereafter (shown in FIG. 6C), and if there is sufficient viewing real estate on the display device 112, immediately next to the home blade 202a. The navigation header shows the user where in the journey 600 the user is presently, and two selectable elements 630, 632 are presented with labels “start feedback” and “full history” in the insights blade 202b. This blade 202b includes a summary of “insights” into a selected procedure, which shows at a glance the resident R1's competency for a number of assessed steps in the selected procedure P3. In this example, the procedure P3 (abdominal hysterectomy), has ten key procedural steps 626 for which the resident R1 has been rated or evaluated. The skill level ratings 628 are shown next to each of the procedural steps 626 in the insights blade 202b. In this example, at least one faculty member has already assessed or rated the resident R1's competency in each of the ten procedural steps for this procedure P3. For example, for the “position patient” procedural step, the resident R1 has received an average rating of apprentice (shown as A in the skill level rating 628 column). But on the “abdominal entry/pelvic survey” procedural step, the resident R1 has received a rating of competent (C). In this example, when the rating for a procedural step is apprentice or better, these ratings can be shown to be visually distinct from ratings assessed at novice or advanced novice only. For example, the apprentice or better ratings can be shown in a first color such as green, whereas the novice and advance novice ratings can be shown in a second color, such as red or purple, to visually distinguish where a threshold competency of apprentice or better has been achieved for a particular procedural step. The skill level ratings can be representative of an average of all ratings submitted by trainers (faculty members) for the given procedural step.

In addition, the insights blade 202b includes an overall self-rating by the resident R1 for the selected procedure (P3), which represents the resident R1's self-rating for the procedure P3. The insights blade 202b also displays an overall faculty rating for the selected procedure P3, which represents an average of all the faculty that have submitted skill level ratings for the procedure P3. This average can be weighted to take into account subjective factors such as faculty or scoring bias, faculty or evaluator leniency in rating residents or trainees, or relative frequency that a faculty (evaluator or reviewer) assesses other residents (or trainees). As mentioned above, the calculated average can be based on at least scores indicated by reviewers and optionally other parameters, such as subjective factors mentioned above. Colored bars, progress meters, colored charts, or other graphical representations can be used to represent on the display 112 insights that reflect the trainee's progress through a training program or through selected competencies, skills, or procedures. These graphical representations can also show one trainee's relative progress to other trainees also participating in the same training program. Having these insights displayed instantly and in real time on any visible blades allow both trainees and reviewers alike to have instant insight into a trainee's individual progress and progress relative to others in the training program. As many reviewers begin to submit scores and feedback into the system 100, the progress bars and other graphical representations displayed on insights blades on all applicable computers 102 in the system 100 will instantly reflect all updates made throughout the system 100. The feedback to the trainee is immediate and intuitive, which improves the overall quality of the training program by creating an open environment where all scores and progress are visible to all users instantaneously. The system 100 encourages competition among trainees to stay abreast of their colleagues in the program, and improves the quality of feedback and scores provided by the reviewers. Reviewers who have not submitted feedback or scores can be weighted lower and lower as more time lapses between submissions, reducing that reviewer's “influence” in the training program. Similarly, reviewers who are “too harsh” or “too lenient” in their submissions can be weighted lower and lower to reduce those reviewers' influence in the training program. Thus, reviewers are also incentivized to participate in the training program by timely submitting reviews and also to calibrate their feedback to be reasonable and in line with normal expectations of their peer reviewers. These characteristics are realized through the exposure of information using computer technology contemplated by the present disclosure.

In this example, the user R1 has selected a selectable element P3 associated with a procedure that is labeled “Hysterectomy: Abdominal.” In FIG. 6D, the user R1 has selected the selectable element 632 to view the full history of the selected procedure P3. Upon selecting the selectable element 632, a history blade 202c is displayed immediately on the display device 112. A list 640 of faculty members F1, F2, F3, F4, and F5 in this example, is shown, indicating that five faculty members have submitted ratings for the selected procedure P3 for resident R1. The last date 642 that each of the reviewing faculty members submitted feedback is displayed, along with the consolidated skill level rating 644 as assessed by each faculty member F1, F2, F3, F4, F5 for the resident R1.

In FIG. 6E, the user has selected the selectable element 630 to start a new feedback for the selected procedure P3 in the insights blade 202b. The history blade 202c is immediately replaced with a feedback blade 202d such that the history blade 202c is removed from the display device 112. A list of available faculty members 646 who can conduct a review is displayed in the feedback blade 202d, and each of the faculty members 646 represents a selectable element.

Here, it is noted that the resident R1 can “pose” as a faculty member and make the inputs that the faculty member would normally make. However, to submit any feedback or rating, the faculty member must enter his or her authentication credentials as described herein. The resident, who is the one receiving feedback, is the more likely of the two interacting persons to be eager to have feedback and ratings entered, so the present disclosure contemplates that the resident may very well make the initial inputs into the blades, but the actual submission of any new feedback or ratings will require the faculty's authentication credentials to be inputted and accepted.

In FIG. 6F, after the selectable element corresponding to the faculty member F5 has been selected, a new feedback blade 202e is displayed on the display device 112, with procedural steps 660 to be assessed corresponding skill level ratings 662 for the selected procedure P3. Here, the faculty member F5 is assessing the resident R1 for this procedure P3, and either the faculty member F5 or the resident R1 inputs the skill level ratings 662 for each of the procedural steps 660 for the procedure P3. If the user interface device 110 includes a touchscreen, the user simply needs to touch in the box corresponding to the desired skill level rating 662 to input the rating for any given procedural step 660. A vertical scroll bar can be provided to allow the user to scroll down on the new feedback blade 202e to view all of the feedback that can be provided for the procedure P3.

FIG. 6G shows additional feedback that was obscured in FIG. 6F in the new feedback blade 202e. Here, the faculty member F5 is asked whether the procedural steps were reviewed with the resident R1 in the area 664. In the resident input area 666, the resident R1 is offered a text entry area 666 to indicate things during the procedure P3 that the resident R1 believes he or she did well and things he or should could have improved. Likewise, the faculty F5 is offered a text entry area 668 to indicate things during the procedure P3 that the faculty member F5 believed the resident did well and things the resident could have improved. As mentioned above, in the faculty authentication area 670, the faculty member F5 must enter his or her password or other authentication credentials to submit the feedback on the blade 202e. Once the authentication credentials have been entered by the faculty member F5, a selectable element in the form of a “submit feedback” button 672 is selected to submit the feedback entered in the blade 202e.

In FIG. 6H, the user R1 has gone back to the home blade 202a and selected another procedure P5, called Hysterectomy: Vaginal. For this procedure P5, four reviews have been submitted by different faculty members for the resident R1. Upon selecting the selectable element corresponding to the procedure P5, a new insights blade 202b′ is displayed immediately adjacent to the home blade 202a with procedural steps that are associated with the selected procedure P5 along with corresponding skill level ratings for each procedural step. While the format or layout of the selectable and informational elements for the insights blade 202b′ can be the same as the format and layout for the insights blade 202b, the content of the selectable and information elements is different and relevant to the selected procedure, which in this example is a vaginal hysterectomy.

In FIG. 6I, the user R1 has selected the selectable element 632 corresponding to “full history” to request detailed feedback submitted by the four reviewers of the procedure P5. Once the selectable element 632 is selected, a history blade 202c′ is displayed immediately adjacent to the insights blade 202b′ along with a summary of the four faculty reviewers (here labeled F3, F4, F7, and F8 for ease of discussion, but these labels can correspond to initials, nicknames, facial photographs, names, or any other identifying indicia of the faculty member) of the procedure P5 as performed by the resident R1, along with the date of the review and the skill level rating assessed by the faculty reviewer. It should be emphasized that when the selectable element 632 is selected, no previously displayed blades are changed. The display device 112 is updated only to display the history blade 202c′.

In FIG. 6J, the user R1 has selected to see the feedback submitted by the faculty member F3 for the resident R1's performance of the procedure P5. Selecting a selectable element 676 labeled “start feedback” allows the user start a new feedback for the selected procedure. Here, the user has selected the first faculty member F3 displayed in the history blade 202c′ to see the feedback submitted by the faculty member F3 for the procedure P5 as performed by the resident R1, which causes a feedback blade 202f to be displayed immediately adjacent to the history blade 202c′. A selectable element 678 labeled “update” in the feedback blade 202f allows the faculty member F3 to update or change previously submitted feedback, and any submitted changes will be updated dynamically and in real time in all affected blades or their corresponding data structures.

In FIG. 6K, the user has selected the selectable element 678 in the feedback blade 202f to update feedback on the procedure P5 previously submitted by the faculty member F3, which causes a new feedback blade 202g to be displayed immediately adjacent to the feedback blade 202f. The new feedback blade 202g has input elements for both the resident R1 and the evaluating faculty member F3 to submit feedback. For example, in a first area 680, the faculty member F3 has the option to indicate whether the faculty member F3 reviewed key procedural steps for the procedure P3 with the resident R1. Selectable elements labeled yes and no can be selected accordingly. A second area 682 has text entry boxes for the resident R1 to indicate one or more things she or he believes did well during the procedure P3 and one or more things that could have been improved from the resident's viewpoint. This self-evaluation of the resident R1 can be used for comparative purposes or to allow different perspectives to emerge from a feedback session evaluating the same procedure. A third area 684 includes text entry boxes for the reviewing faculty member F3 to enter his or her feedback on what the resident R1 did well during the procedure P3 as well as things the resident R1 could improve upon. The example text provided in the text boxes are merely illustrative and do not necessarily reflect serious feedback that would be supplied by the resident R1 or the faculty member F3. A fourth area 686 requires the faculty member F3 to enter authentication credentials before selecting the selectable element 688 labeled “submit” to submit the feedback entered on the new feedback blade 202g. Immediately, any other blades whose data is affected by the updated feedback entered in the new feedback blade 202g are updated and displayed on the display device 112 is there is sufficient viewable real estate to view it. The results of all calculations carried out by one or more of the modules 410, 412, 414 of the server 106 based on the data entered into the new feedback blade 202g are published to the corresponding blades whose data is affected by the calculation results.

As mentioned above in FIG. 5A, there are two types of feedback that can be supplied using the system 100: milestones feedback (504) and surgical skills feedback (506). Feedback quantified in the form of skill level scores or competency level scores based on skill level ratings or goals achieved is updated dynamically and in real time across all blades impacted by any change to a trainee's skill level score or competency level score. All other trainees and trainers can view in real time any changes that occur immediately as the changes ripple throughout the system 100, such as using the publish-subscribe model shown above. In addition, a global score, grade, or rating can be displayed for each trainee, and this global score can be calculated as a function of both the trainee's skill level score and competency level score. In addition, a trainer's scores can be weighted to account for subjective differences in how harsh or lenient a trainer rates the trainees. Lower weights can be assigned to harsh or lenient trainers so that their scores have a lower influence on a trainee's feedback rating or score. Whether a trainee achieves a particular competency level can be determined based on the number of goals achieved as assessed by a threshold number of trainers. The scores, levels, goals, ratings, and feedback can be quantified as numbers, real or integer, percentages, bar graphs, letters (such as school grades), and the like. They can be color-coded so that when a certain threshold competency is achieved, the color changes so that they are visually distinguishable from other competencies and scores for other procedures or skills where the trainee has not yet achieved a threshold competency. In some aspects, all trainers and trainees have visibility to view or access any other trainer or trainee's information in the system 100, which produces a competitive and comparative environment where trainees can compare their progress against other trainees and also compete with other trainees to complete milestones and acquire skills.

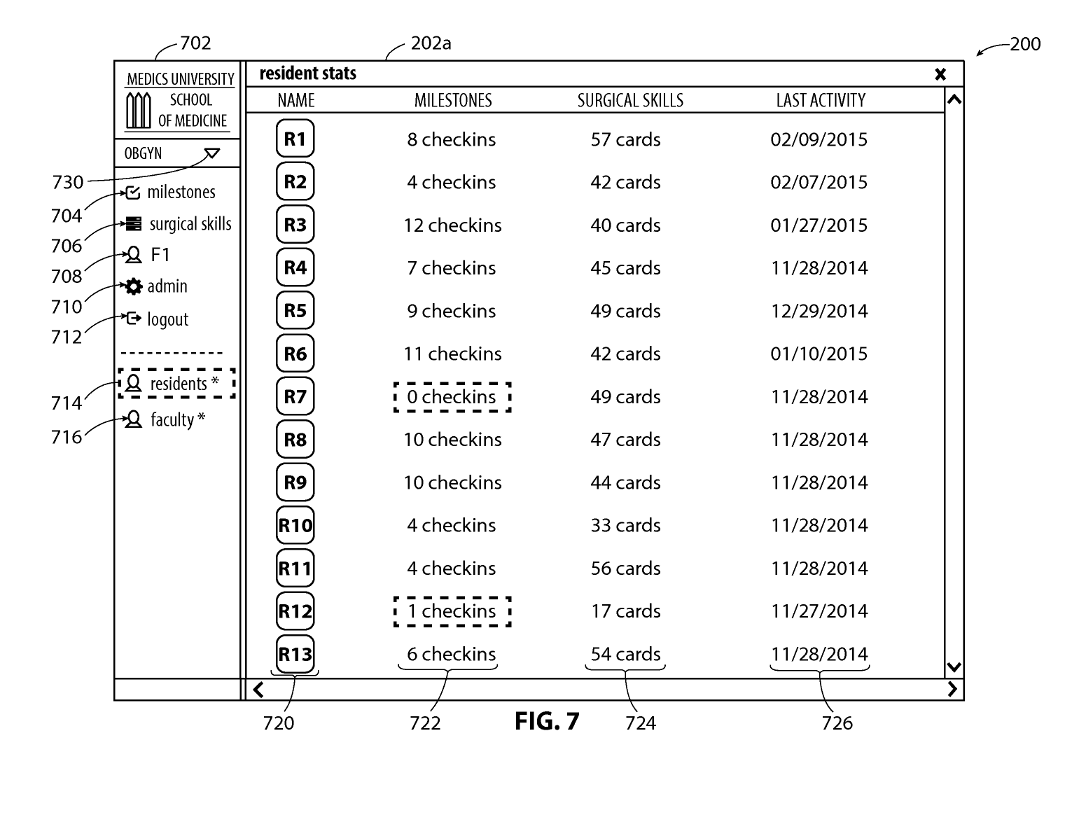

FIG. 7 is an example start of a journey displayed on a display device 112, starting with a main navigation menu 702 in which a user has selected to view overall stats on all the residents participating in a training program. This main menu 702 is always displayed on the display device 112 no matter how many blades are shown to the right of the menu 702. This menu 702 shows the name of the hospital or university associated with the feedback being carried out, and the particular medical specialty, which in this example is OB/GYN. A selectable element 704 bearing the label “milestones” is presented on the display device 112 along with another selectable element 706 bearing the label “surgical skills.” In the example of FIG. 7, there are two types of feedback that can be provided. One evaluates overall competencies mastered by the trainee, here called milestones, and the other evaluates surgical skills in the operating room mastered by the trainee. In this example, a trainer or faculty member, designated by F1 in the area 708, has logged into the interactive session to evaluate one or more trainees or residents. Thus, the faculty member F1 has already supplied his or her authentication credentials, and is therefore authorized in this interactive session to submit feedback on the trainee(s) under evaluation. An interactive session as used herein can begin with the logging in of a trainee or trainer, and can be completed when the logged in user logs out (e.g., by selecting the logout selectable element 712 in the main menu 702). In this example, the trainer, F1 708, desires to see an overall assessment for some or all of the residents (trainees) in the OBGYN training program. Each of the residents (trainees) in the column 720 are shown as R1, R2, and so forth to R13 for ease of discussion. However, as discussed above, the residents can be graphically portrayed on the video display 112 by their initials, a photograph, or the like. The second column shows, for each resident, how many evaluations have been submitted for the competencies or milestones. As mentioned above, one of the advantages of the present disclosure is that all reviewers and all trainees can see how many evaluations or submissions have been made for each trainee. In this way, reviewers who do not submit reviews or trainees who do not complete milestones or procedures, will quickly be flagged on blades such as the home blade 202a shown in FIG. 7. Here, the resident R7 has no checkins for any milestones, which means that no reviewer has submitted any score or feedback for resident R7 for any competency. This could be the reviewer or the trainee's fault. This is highlighted in the home blade 202a by visually distinguishing the number of milestones checkins for the resident R7, such as by highlighting the text label “0 checkins,” drawing a box around it, or indicating the label or the box in a contrasting color, such as red, or any combination of the above. The idea is that the user, here F1 who can be a program administer, for example, can quickly see which residents need attention, and can take immediately action to understand why the resident R7 has no checkins for any competency. Again, this could be the fault of the reviewer or the trainee, but now the faculty member F1 is armed with the information to know what area to focus on and for which resident. Likewise, the user F1 can also see that resident R12 has only 1 checkin (competency score submission) for any competency, and that resident R12 is also flagged by a distinguishing indicia, such as a red color, a box, or the like to visually differentiate this resident R12 from the others who are not so flagged.

The home blade 202a also displays a summary column 724 of surgical skills feedback, and the number of procedures that have been scored or for which feedback has been submitted by a reviewer for each of the residents identified in the column 720. Here again, any resident that does not have a threshold level of feedback submitted for surgical skills is flagged by some visually distinguishable indicia on the display device 112. Here, no such residents exist, as even R12 has 17 “cards” or surgical skills or procedures that have been evaluated and for which feedback has been submitted by one or more faculty members. The last column 726 shown in the home blade 202a shows the date of the last activity for the resident identified in the first column 720. Here again, any resident who has not had any activity within a predefined period in the past, such as in the last 3 months, will be flagged, and the corresponding date in the last column 726 will be flagged by some visually distinguishable indicia. The faculty administrator, which in this example is F1, can change the predefined period by selecting the admin selectable element 710, which calls up an admin blade (not shown), where the administrator can adjust settings like the predefined period, or a threshold number of checkins, or surgical cards before they are red-flagged. Having all the competencies and surgical skills for all the residents displayed on a single home blade 202a is powerful information to the faculty administrator F1. It allows the faculty administrator F1 to take immediate action to address any shortcomings in the program evaluation. Without this program-level perspective, faculty administrators have heretofore had little to no insight as to where deficiencies should be addressed in a program. Faculty administrators tasked with successfully administering and executing a training program now have a powerful additional tool at their disposal to ensure program success, not only for the trainees but also for the faculty members who themselves may not have the high-level view of evaluative deficiencies in the program. Likewise, the program-level insights are not limited to residents only; the main menu 702 also has a selectable element 716 labeled “faculty” where the administrator F1 can see a summative blade of all the faculty members or trainers in the program and how many evaluations they have completed for competencies and surgical skills and the last time they completed an evaluation. This allows the administrator to lean on any faculty members who may be taking too long to submit feedback for residents. This also allows the administrator to track actual performance assessments against reporting requirements to ensure that the university or program administration stays on track to meet or exceed reporting requirements imposed by an accreditation council or similar organization, such as the Accreditation Council for Graduate Medical Education (ACGME).

The faculty or program administrator can also generate reports that can be printed out or emailed, which show some, any, or all of the following. The report can include:
The total number of milestone checkins performed over a date range that matches reporting periods (such as imposed by ACGME) or time periods entered by trainers or trainees.
The total number of surgical skills feedback assessments performed over a date range that matches reporting periods (such as imposed by ACGME) or time periods entered by trainers or trainees.
The total number of milestone checkins performed for all trainees in the program.
The total number of surgical skills assessments performed for all trainees in the program.
A graphical representation of the last N weeks for surgical skills assessments completed and submitted by trainers, where N is an integer selectable by the program administrator.
Milestones checkins adoption data on a trainer by trainer basis who have completed a checkin and by a percentage of trainees having at least one checkin.
A milestone venue chart showing a distribution of how many checkins occurred for each particular milestone (competency).
A milestone level chart showing the distribution of milestones across all trainee's at each level.
Milestones and surgical skills assessments integrated together with a detailed comment data for each reviewee, which can be presented to ACGME for auditing purposes.

As mentioned above, aspects disclosed herein dramatically reduce the number of machine states that the computer system must keep track of, dramatically reduces UI churn on the display device, which frees up the computer processing equipment to perform other tasks and uses less memory. Moreover, the requirement of faculty authentication to submit feedback allows the resident to use his or her own credentials to “ghost write” his or her own feedback, and then the faculty member simply needs to enter authentication credentials just prior to submitting. This allows the resident to access input fields that would otherwise be off limits to an unauthenticated user, and this access facilitates personal collaboration and efficacious feedback delivery while the resident and faculty are mutually present and using the system 100. Requiring the faculty authentication ensures that only the faculty member actually submits the feedback, but as mentioned above, the resident (who is not authorized to submit feedback) can still access and input feedback as if the resident were the faculty member.

The following source code examples for implementing a publish-subscribe model using topics.

The following example source code extends the jquery functionality to use topics in the main.js module.

```
// extending jquery functionality
    $.Topic = function (id) {
      var callbacks,
        topic = id && topics[id];
      if (!topic) {
        callbacks = jQuery.Callbacks(“unique”);
        topic = {
          publish: callbacks.fire,
          subscribe: callbacks.add,
          unsubscribe: callbacks.remove
        };
        if (id) {
          topics[id] = topic;
        }
      }
      return topic;
    };
```

The following example source code shows BladeManager subscription actions.

```
      // subscribe to the open blade topic
      $.Topic(“openBlade”).subscribe(_eventOpenBlade);
      // subscribe to the refresh Journey topic to update UI when data
      changes
      $.Topic(“refreshJourney”).subscribe(_eventRefreshJourney);
      //subscribe to the remove blade topic
      $.Topic(“gcBlades”).subscribe(_eventGCBlades);
      The following example source code shows BladeManager actions.
      BladeManager actions
      // Define the class methods
        BladeManager.prototype = {
          openBladeExperience: function (targetbladeId, params) {
            // close blades first
            _actionCloseBlades(_helperGetBladesToClose(_.
keys(activeBlades)[0], false), false);
            // and then open the requested blade
            _actionOpenBlade(“start”, targetbladeId, params);
          }
      refreshBlade: function (bladeId, params) {
            if (_.has(activeBlades, bladeId)) {
              // and now refresh the target blade
              $.when(
                activeBlades[bladeId].refresh(params)
              ).done(function (result) {
                _actionShowSourceProgressBar(bladeId, false);
              }).fail(function (result) {
                //stop showing the progress bar
                _actionShowSourceProgressBar(bladeId, false);
                $.Topic(“eventShowAppGlobalError”).publish(result.
                statusText);
              }).progress(function (value) {
                // show the progress bar; notify after an interval
                _actionShowSourceProgressBar(bladeId, true);
              });};
```

While this disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of the invention as defined by the appended claims.

Each of these embodiments and obvious variations thereof is contemplated as falling within the spirit and scope of the claimed invention, which is set forth in the following claims. Moreover, the present concepts expressly include any and all combinations and sub-combinations of the preceding elements and aspects.

What is claimed is:

1. A computer-implemented method of facilitating real-time competency-based feedback by a trainer to a trainee in a training environment for independent professional practice, using a computer, comprising the steps of:
during or immediately following an interaction in the training environment for independent professional practice where the trainer observes during the interaction the trainee interacting with a third party in which a medical service is being rendered to, or a medical procedure is being performed on, the third party by the trainer or by the trainee or by both, initiating an interactive session on a client computer and responsive thereto receiving input from a user interface device of the client computer indicative of at least one goal of a plurality of goals achieved by the trainee during the interactive session and causing to be displayed within a first frame on a display device of the client computer in the setting an indication of the at least one goal achieved, the plurality of goals being associated with a selected competency of a plurality of competencies and each of the plurality of goals being associated with one of a plurality of levels within the selected competency;
publishing a topic indicating that the at least one goal has been achieved and notifying a subscriber manager controlled by a server computer that the input has been received relative to the first frame;
a subscriber in the subscriber manager instructing a second frame to refresh a competency level score based on the received input indicating the at least one goal;
calculating a new competency level score for the selected competency based on the number of goals from among the plurality of goals inputted as being achieved by the trainee, and displaying simultaneously with the first frame, within the second frame on the display device, a representation based on at least the calculated competency level score without refreshing objects displayed in the first frame.

2. The method of claim 1, further comprising the steps of:
receiving, via the user interface device or another user interface device, authentication credentials associated with the trainee to login the trainee to the interactive session;
responsive to authenticating the authentication credentials associated with the trainee, initiating the interactive session;
after receiving the input from the user interface device and before the publishing, receiving a selection corresponding to a username of the trainer and displaying in the first frame, the second frame, or a further frame, an indication for the trainer to input an authentication credential associated with the trainer;
receiving, via the user interface device or another user interface device, during the interactive session an authentication credential associated with the trainer to login the trainer to the interactive session; and
responsive to authenticating the authentication credential associated with the trainer, receiving, via the user interface device, a confirmation to submit the input indicative of at least one goal and then carrying out the publishing.

3. The method of claim 1, further comprising the step of:
during the interactive session, in response to receiving from the user input device a selection input selecting an object displayed in a selected frame displayed on the display device, where the selection input requires displaying additional information on the display device, displaying a new frame on the display device immediately adjacent to the selected frame.

4. The method of claim 3, wherein the selected frame is the first frame or the second frame or a further frame displayed on the display device, and the new frame is another of the first frame or the second frame or the further frame.

5. The method of claim 4, further comprising the step of:
each time a new frame is added to be displayed on the display device, displaying the new frame immediately adjacent to the last frame that was displayed on the display device, such that all frames displayed on the display device appear in a temporal order in which each such one of the frames was added to be displayed on the display device.

6. The method of claim 1, further comprising the step of:
during the interactive session, in response to receiving from the user input device an input to close any selected frame among a plurality of frames displayed on the display device, removing from display on the display device the selected frame and all other frames that were displayed after the selected frame.

7. The method of claim 1, further comprising the step of:
during the interactive session, in response to receiving from the user input device an input made in a selected frame among a plurality of frames displayed on the display device, removing from the display those of the plurality of frames that were added after the selected frame and displaying a new frame immediately adjacent to the selected frame.

8. The method of claim 1, further comprising the steps of:
displaying on the display device within a third frame a plurality of procedural steps performed within one of a plurality of procedures by the trainee;
receiving input from the user interface device indicative of a skill level rating for a selected one of the plurality of procedural steps;
publishing the inputted skill level rating to the subscriber manager; and
calculating a skill level score for the selected procedure step based on the skill level rating, and displaying simultaneously within the third frame, within a fourth frame whose objects are controlled by a second subscriber on the display device, a representation based on at least the calculated skill level score without refreshing objects displayed in the third frame.

9. The method of claim 8, further comprising the steps of:
responsive to the interactive session being initiated by receiving authentication credentials associated with the trainee, displaying in the fourth frame an indication for the trainer to input an authentication credential associated with the trainer;
receiving, via the user interface device or another user interface device, during the interactive session an authentication credential associated with the trainer to login the trainer to the interactive session together with the trainee; and
responsive to authenticating the authentication credential associated with the trainer, receiving, via the user interface device, a confirmation to submit the input indicative of the skill level rating, wherein the displaying the representation based on at least the calculated skill level score is carried out responsive to receiving the confirmation to submit the input indicative of the skill level rating.

10. The method of claim 1, wherein the first frame and the second frame are decoupled from one another.

11. The method of claim 1, wherein the publisher is decoupled from the subscriber.

12. A computer-implemented method of facilitating real-time competency-based feedback from a trainer to a trainee in a training environment for independent professional practice, using a computer, comprising the steps of:
initiating, responsive to authenticating authentication credentials associated with the trainee or responsive to authenticating authentication credentials associated with the trainer, an interactive session on a computer;
during the interactive session, receiving, via a user interface device associated with the computer, inputs indicative of a plurality of goals achieved by the trainee, each of the goals being associated with one of a plurality of competency levels related to the independent professional practice;
responsive to receiving each of the inputs indicative of the plurality of goals achieved by the trainee and during the interactive session, computing a competency level score for the associated one of the competency levels based on those of the goals achieved by the trainee and associated with the associated one of the competency levels, wherein the computing the competency level score is carried out only when the authentication credentials associated with the trainer have been authenticated;
responsive to the computing, displaying on a display device a representation based on at least the competency level score during the interactive session;
during the interactive session, receiving, via the user interface device, inputs indicative of a plurality of skill level ratings each associated with one of a plurality of procedural steps related to the independent professional practice;
responsive to receiving each of the inputs indicative of the plurality of skill level ratings and during the interactive session, computing a skill level score based on those of the skill level ratings for the associated one of the plurality of procedural steps, wherein the computing the skill level score is carried out only when the authentication credentials associated with the trainer have been authenticated;
responsive to the computing, displaying on the display device a representation based on at least the skill level rating during the interactive session; and
responsive to the interactive session being initiated responsive to authenticating the authentication credentials associated with the trainee:
receiving during the interactive session, via the user interface device or another user interface device, authentication credentials associated with the trainer; and
authenticating the authentication credentials associated with the trainer to log the trainer in to the interactive session with the trainee.

13. The method of claim 1, wherein the representation based on at least the calculated competency level score is a color-coded bar or a progress meter.

14. The method of claim 13, wherein the representation based on at least the calculated competency level score is also based on at least scoring bias, a frequency of scoring by the trainer, or trend information indicative of an assessment of the trainee's scores or overall progress in the training environment.
